(19) United States
(12) Patent Application Publication
(10) Pub. No.: US 2024/0273359 A1
(43) Pub. Date: Aug. 15, 2024

(54) APPARATUS AND METHOD FOR DISCOVERING BIOMARKERS OF HEALTH OUTCOMES USING MACHINE LEARNING

(71) Applicant: AIQC, Inc., Revere, MA (US)

(72) Inventor: Layne Sadler, Revere, MA (US)

(73) Assignee: AIQC, Inc., Revere, MA (US)

(21) Appl. No.: 18/540,545

(22) Filed: Dec. 14, 2023

Related U.S. Application Data
(60) Provisional application No. 63/444,893, filed on Feb. 10, 2023.
(60) Provisional application No. 63/523,832, filed on Jun. 28, 2023.
(60) Provisional application No. 63/432,611, filed on Dec. 14, 2022.

(51) Int. Cl. G06N 3/08

(52) U.S. Cl. CPC G06N 3/08

(57) ABSTRACT

An apparatus for discovering biomarkers of cancer using machine learning includes at least a processor and a memory containing instructions configuring the at least a processor to receive a plurality of patient data, wherein each element of patient data includes clinical outcome data and molecular data, generate training data using the plurality of patient data wherein the training data correlates molecular data to clinical outcome data, and train, using the training data, a neural network to predict clinical outcomes based on molecular data.

### CROSS-REFERENCE TO RELATED APPLICATIONS

This application claims the benefit of priority of U.S. Provisional Patent Application Ser. No. 63/444,893, filed on Feb. 10, 2023, and titled “APPARATUS AND METHOD FOR DISCOVERING BIOMARKERS OF HEALTH OUTCOMES USING MACHINE LEARNING,” which is incorporated by reference herein in its entirety. This application also claims the benefit of priority of U.S. Provisional Patent Application Ser. No. 63/523,832, filed on Jun. 28, 2023, and entitled “APPARATUS AND METHOD FOR DISCOVERING BIOMARKERS OF HEALTH OUTCOMES USING MACHINE LEARNING,” which is incorporated by reference herein in its entirety. This application further claims the benefit of priority of U.S. Provisional Patent Application Ser. No. 63/432,611, filed on Dec. 14, 2022, and entitled “METHODS AND SYSTEM FOR BIOMEDICAL ANALYSIS THAT PREDICTS PHENOTYPES AND RANKS CORRESPONDING BIOMARKERS,” which is incorporated by reference herein in its entirety.

### FIELD OF THE INVENTION

The present invention generally relates to the field of bioinformatics and drug target discovery. In particular, the present invention is directed to an apparatus and method for discovering biomarkers of health outcomes using machine learning.

### BACKGROUND

At present, prognostic and diagnostic methods for discovering biomarkers of health outcomes are poorly developed. Clinicians typically use invasive techniques such as tissue biopsies to acquire relevant patient data which may be both more painful for the patient and biologically inaccurate.

### SUMMARY OF THE DISCLOSURE

These and other aspects and features of non-limiting embodiments of the present invention will become apparent to those in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an apparatus for discovering biomarkers of health outcomes using machine learning;

FIG. 2 is a chart illustrating a set of biomarkers with permuted feature importance;

FIG. 3 is a table including survival predictor genes and annotated information;

FIG. 4 is a table of machine learning training parameters to an embodiment of the invention;

FIG. 5A is a table illustrating a training data consisting of survival-differentiated functional gene mutations that may be utilized in an exemplary workflow in one embodiment of the present invention;

FIG. 5B is a chart illustrating results of a particular data set that may be utilized in an exemplary workflow in one embodiment of the present invention;

FIG. 6 is a table illustrating results of a particular data set that may be utilized in an exemplary workflow in one embodiment of the present invention;

FIG. 7 is a table illustrating particular algorithm performance metrics which may be utilized in an exemplary workflow in one embodiment of the present invention;

FIG. 8 is a logistic function plot representing aspects of a neural network process that can be used to permute molecular features in order to quantify the importance of the molecular biomarkers related to health outcomes;

FIG. 9 is a set of charts illustrating algorithm prediction performance that may be utilized in an exemplary workflow in one embodiment of the present invention;

FIG. 10 is a diagrammatic representation of aspects of a machine learning process that can be used to discover biomarkers of health outcomes;

FIG. 11 is a diagrammatic representation of aspects of a neural network process that can be used to permute molecular features in order to quantify the importance of molecular biomarkers;

FIG. 12 is a diagrammatic representation of a node of a neural network;

FIG. 13 is a flow diagram illustrating an exemplary embodiment of a method;

FIG. 14 is a schematic diagram illustrating final output of a method as described herein;

FIG. 15A is an illustration of protein-protein interaction network derived from functionally mutated gene set in bladder cancer survival;

FIG. 15B illustrates a table of pathway enrichment for reactions between genes in interaction network;

FIG. 16 illustrates a table of survival predictor genes from an expanded study;

FIG. 17A illustrates a table of identified genes with which prioritized microRNA are predicted to bind;

FIG. 17B is an illustration of protein—protein interaction network derived from miRNA-binding genes;

FIG. 17C illustrates a table of pathway enrichment for reactions between genes in interaction network;

FIG. 18 illustrates an exemplary graph used for determining a plurality of variant weights;

FIG. 19 illustrates a table showing a sample of a set of random genetic variants and corresponding gene scores;

FIG. 20 is a flow diagram illustrating an exemplary embodiment of a method of discovering biomarkers of health outcomes using machine learning; and

FIG. 21 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

Research into predicting health outcomes has thus far focused on cancer somatic mutation. Historically, genetic mutations (e.g. BRCA family) in germline DNA derived from peripheral blood cells have been explored from the standpoint of hereditary risk linked to the development of cancer. However, in a purely prognostic research setting where all patients are diseased, apart from the extrapolation of early risk factors like BRCA, germline DNA has been ignored in favor of tumor-specific omics such as Tumor-Normal Mutations and metrics thereof like Tumor Mutation Burden. Additionally, traditionally association studies (like GWAS) have been used that test individual SNPs for correlation with a health outcome in isolation. However, aspects of the present disclosure are directed to training a neural network on all gene-level mutations in unison. Neural networks may be used to make predictions about individual samples, while association studies cannot provide this functionality. Aspects of the present disclosure also are directed to the use of weighting a variant based on mutational functionality, rarity, zygosity, and structure to exclude gene variants that do not substantially impact the utility of the protein that the gene ultimately produces.

At a high level, aspects of the present disclosure are directed to systems and methods for discovering biomarkers of cancer and/or health outcomes using machine learning. In an embodiment, methods and apparatuses described herein may be used to assess and predict patient mortality based on patient data, clinical outcome data and molecular data.

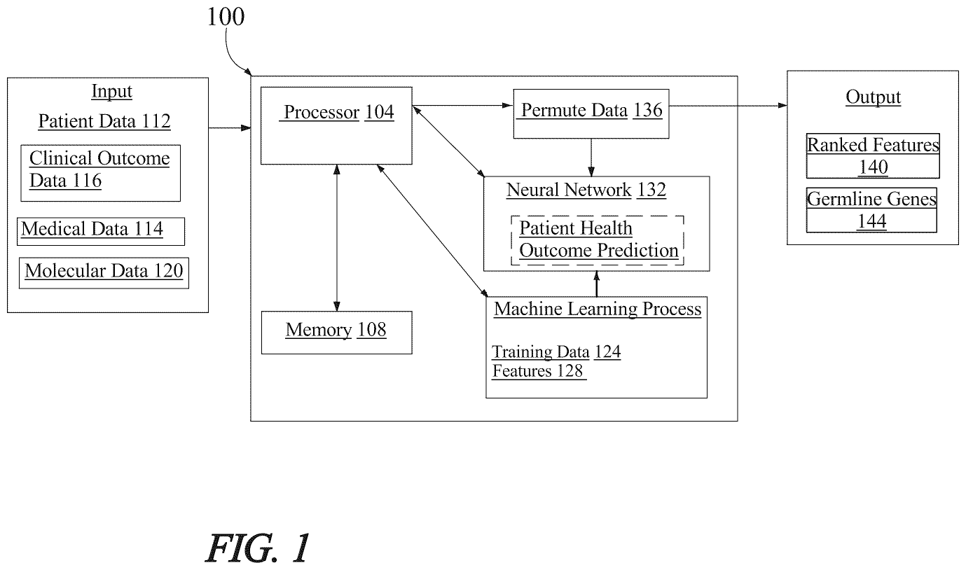

Referring now to FIG. 1, an exemplary embodiment of an apparatus 100 for discovering biomarkers of health outcomes using machine learning is illustrated. Apparatus 100 may include and/or be incorporated in a processor 104. Processor 104 may include and/or be incorporated in any computing device as described in this disclosure, including without limitation a microcontroller, microprocessor 104, digital signal processor 104 (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory 108 between computing devices. Computing device may be implemented using a “shared nothing” architecture in which data is cached at the worker, in an embodiment, this may enable scalability of apparatus 100 and/or computing device.

With continued reference to FIG. 1, processor 104 and/or computing device may be designed and/or configured to perform any method, step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 and/or computing device may perform any step or sequence of steps as described in this disclosure in parallel, such as simultaneously and/or substantially simultaneously performing a step two or more times using two or more parallel threads, processor 104 cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, apparatus 100 and/or processor 104 is configured to receive a plurality of patient data 112 wherein each element of patient data 112 includes clinical outcome data 116 and molecular data 120. As used in this disclosure, “patient data” 112 is information held about individual patients. In some embodiments, patient data 112 may include medical data 114 regarding a patient. For example, in some embodiments, medical data 114 may include information relating to past and current illness, treatment history and lifestyle choices. As used in this disclosure, “clinical outcome data” 116 is measurable changes in health, function, and life quality as a result of medical care. For example, clinical outcome data 116 may include treatment-related mortality rates or treatment readmission rates. As used in this disclosure, “molecular data” 120 is bioinformatics data relating to the inherited or acquired molecular characteristics of individual patients which may reveal useful information related to the physiology or the health of that person and which result, in particular, from an analysis of a biological sample from that patient. For example, molecular data 120 may include genetic mutation data, such as the mutation status of genes associated with cancer. In some embodiments, molecular data 120 may include germline blood cell data. Molecular data may include, without limitation, one or more types of mutations found in one or more genomes, epigenomes, proteomes, or transcriptomes of cells; mutations may be specific to particular cells or subclonal populations within a tumor, particular varieties of tumor and/or cancerous cells, or the like. In some cases, molecular data may also include one or more differences in the levels of expression in the transcriptome and proteome. Molecular data may further include information describing prevalence of a given mutation and/or genome, epigenome, transcriptome or proteome within a population of cancer cells within a patient. For example, and without limitation, all cancerous cells within a patient may have a first mutation, while a percentage less than 100% of such cells may have a second mutation. Identification of genomes, mutations, or the like in a given patient, as reflected in patient data and/or molecular data, may be performed by users such as clinical workers or the like. Alternatively or additionally, one or more genomes, proteomes, transcriptomes, mutations, and/or prevalence of mutations may be performed automatically, for instance using one or more computer and/or microfluidics-controlled processes such as Lumina dye sequencing or the like. Prevalence data may, in a non-limiting example, be determined by extraction and sequencing of multiple samples, cell lines, or the like from a biopsy, extracted tumor, blood sample, or the like.

Still referring to FIG. 1, apparatus 100 is configured to generate training data 124 using plurality of patient data 112, which may be implemented in any manner described in this disclosure. “Training data” 124, as used in this disclosure, is data containing correlations that a machine-learning process may use to model relationships between two or more categories of data elements. For instance, and without limitation, training data 124 may include a plurality of data entries, each entry representing a set of data elements that were recorded, received, and/or generated together; data elements may be correlated by shared existence in a given data entry, by proximity in a given data entry, or the like. Training data 124 may correlate one or more elements of patient data to clinical outcome data. For instance, in some embodiments, training data may correlate molecular data 120 to clinical outcome data. In some embodiments, clinical outcome data may include probabilities for clinical outcomes. For instance, and without limitation, training data 124 may correlate clinical outcome data with patient data 112 indicative of health outcomes. Generating training data 124 may include qualifying genes of the plurality of patient data 112 with respect to health outcomes according to differential and functional molecular mutation.

With continued reference to FIG. 1, the expression of mutations is naturally influenced by structural factors such as but not limited to zygosity, copy number alteration, pseudoautosomal regions, and allosomal dosage compensation. When generating the training data, these mechanisms may be used as multipliers for weighing the impact of a given patient's mutations. For example, if alleles are homozygously mutated (appearing in both maternally and paternally inherited chromosomes), it may be assigned twice the weight of a heterozygously mutated allele (appearing on one chromosome). Since males have a single copy of the X chromosome with upregulated expression, if a male has a variant on X, then it may be weighted as if it were homozygous. Similar proportional approaches may be taken to adjust for male Y and female X chromosomes. If a patient exhibits 3× copy number variation for a given gene, then the mutational weight of that gene may be multiplied by 3. Gene length may not need to be taken into account because gene length is the same in both cases and controls. Furthermore, the multiplier may be adjusted by the genotype quality based on Phred likelihood scores. For example, if there is 98% certainty that a mutation is heterozygous versus opposed to no mutation existing, then the multiplier should be 0.98, not 1.00.

With continued reference to FIG. 1, in some embodiments, generating training data 124 may include qualifying genes of the plurality of patient data 112 using a functional filter. The functional filter may exclude categories of gene variants that do not have severe consequences. For example, the stop-gained category of mutations prematurely terminates the encoding of RNA. Whereas the synonymous category changes a single base pair that does not result in a change in the encoded amino acid. Variant Effect Predictor (VEP) is a tool that is used to annotate variants based on their consequence (e.g. impact of either high, moderate, low, or modifier). For our purposes, we exclude variants labeled as low or modifier impact because these categories of mutations may not influence the function of a protein that a gene ultimately produces.

Within continued reference to FIG. 1, generating training data 124 may include filtering plurality of patient data 112 based on clinical mortality and propensity-matched patient data 112 of the plurality of the patient data 112. Generating training data 124 may include qualifying biomarkers of plurality of patient data 112 with respect to health outcomes according to differential molecular expression. Filtering may, for instance, be used to eliminate patient data and/or clinical outcome data differing to a greater extent than some threshold amount from a typical, mean, or otherwise identified value of a patient data population, for instance and without limitation as determined using a clustering algorithm as described below. It should be noted that the purpose of propensity matching and stratifying patients based on clinical features is to eliminate sources of genetic variation that is unrelated to the disease in question. In a non-limiting example, processor 104 may generate training data 124 in which there is an equal number of Asian patients in both the case and control groups, so that when identifying a subset of the generated training data as described in further detail below—differentiating the genetics of cases and controls, features related to Asian ancestry as opposed to cancer progression are not identified.

With continued reference to FIG. 1, in some embodiments, generating training data 124 may include weighting the genetic mutation data by at least a weighting factor to adjust a plurality of variant weights associated with the genetic mutation data. In some cases, genetic mutations may not be treated equally in one or more processing steps as described herein; instead, genetic mutations may be assigned with one or more weights (i.e., influence), wherein the importance or contribution of each genetic variant in the analysis may be adjusted based on certain criteria. For example, and without limitation, by weighting one or more variants, certain mutations (i.e., data elements of patient data) may be given more or less significance in the generated training data 124 based on one or more weighting factors such as, without limitation, at least an Allele Frequency (AF) and structural impact as described in detail below, allowing system to account for the varying importance of different mutations when generating training data 124. Thus, in some embodiments, such a weighting mechanism may not be arbitrary but is instead meticulously designed to reflect the biological significance of each variant within genetic mutation data.

With continued reference to FIG. 1, in some cases, weighting factor or factors may be automatically selected by processor 104 or manually selected by one or more domain experts from a group of weighting factors consisting of an AF, structural impact (i.e., structural factors as described above), and/or any other relevant biological factors such as, without limitation, prevalence, predicted impact on protein function, among others which may be pivotal in pathogenic assessment of mutations as described herein. In some cases, AF weighting factor, e.g., a maximum AF, may be derived from population genetics data and may be inversely proportional to the frequency of the mutation within a population. The pathogenic mutations are less likely to be prevalent in a population due to negative selection pressures. Consequently, more common mutations may be weighed less heavily as they are less likely to be associated with adverse health outcomes.

With continued reference to FIG. 1, in some cases, structural factors may consider one or more predicted effects of mutations on three-dimensional (3D) structure of, for example, but is not limited to, proteins. In one or more embodiments, processor 104 as described herein may be configured to simulate structural impact of, for example, but is not limited to, amino acid substitutions resulting from missense mutations using one or more advanced bioinformatics tools and algorithms. In some cases, one or more structural prediction models may be generated using one or more machine learning algorithms as described herein, and processor 104 may employ the structural prediction models such as, without limitation, AlphaFold or PrimateAI to determine at least a pathogenicity score for each mutation, wherein the at least a pathogenicity score may reflect a likelihood that a mutation will disrupt protein functions and thus potentially contribute to disease. In some cases, the pathogenicity score may be normalized to a scale from 0 to 1 to facilitate the weighting of variants as described above in a consistent manner.

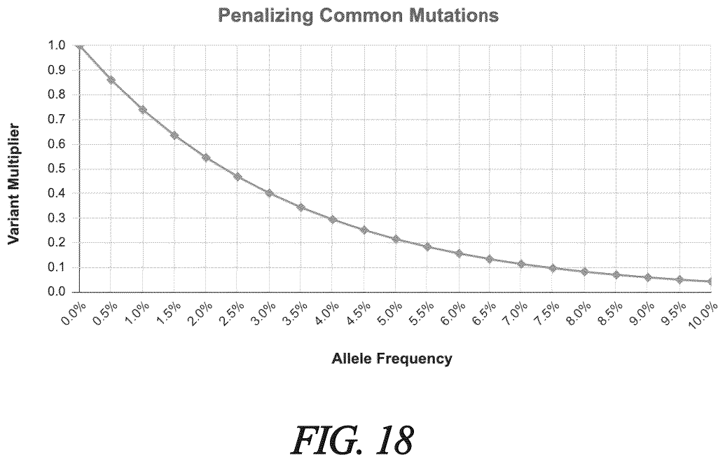

With continued reference to FIG. 1, in a non-limiting example, tumor allelic fraction may be used as a multiplier (i.e., weight). For the purposes of this disclosure, “tumor allelic fraction,” also called “tumor allele fraction” is the fraction of tumor cells in a sample that carry a specific genetic alteration or variant. Additionally, or alternatively, one or more weighting factors as described herein may be applied in a combinatorial manner to generate a composite weight for each variant. Adjusting plurality of variant weights is described in further detail below with reference to FIG. 18.

Filtering of patient data may include classifying and/or clustering patients according to one or more elements of patient data and/or clinical data, wherein features or elements of data according to which to classify it are labeled. Filtering of patient data may use supervised classifiers, which may be used to assign a new object to a class from a given set of classes based on the attribute values of this object and on a training set. Use of classifiers are described in further detail below. For instance, and without limitation, a patient data classifier may classify patient and/or clinical data to one or more labels and/or clusters indicative of common values and/or ranges of values for one or more variables and/or features to be eliminated as potentially confounding, and/or with respect to which uniformity is desired in a population of training data. Classifiers may be trained using training data correlating patient and/or clinical data to labels identifying such groups. Alternatively or additionally, data may be classified using one or more lazy learning protocols and/or processes coupled with one or more criteria, labels, and/or distance metrics for classification. In some embodiments, filtered patient and/or clinical outcome data may be separated from a larger population of patient data and/or clinical outcome data, for use as training data.

Within continued reference to FIG. 1, the apparatus 100 may be configured to generate training data 124 by identifying at least a feature of patient data and/or clinical outcome data 116. As used in this disclosure, the “at least a clinical feature” is at least a factor relating to a course of patient pathology or the observation and treatments of the patients directly, such as a tissue or blood source of DNA, RNA, or proteins. Features may include one or more variables and/or categories of values of patient data to be correlated with clinical outcome data, and/or one or more variables and/or categories of values of clinical outcome data to be correlated with patient data. One or more features may be identified using user instructions.

Continuing refer to FIG. 1, a feature learning and/or clustering algorithm may be implemented, as a non-limiting example, using a k-means clustering algorithm. A “k-means clustering algorithm” as used in this disclosure, includes cluster analysis that partitions n observations or unclassified cluster data entries into k clusters in which each observation or unclassified cluster data entry belongs to the cluster with the nearest mean, using, for instance behavioral training set as described above. “Cluster analysis” as used in this disclosure, includes grouping a set of observations or data entries in way that observations or data entries in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

With continued reference to FIG. 1, computing device may generate a k-means clustering algorithm receiving unclassified patient data and outputs a definite number of classified data entry clusters wherein the data entry clusters each contain cluster data entries. The K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified data entry cluster. K-means clustering algorithm may select and/or be provided “k” variable by calculating k-means clustering algorithm for a range of k values and comparing results. K-means clustering algorithm may compare results across different values of k as the mean distance between cluster data entries and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify data entry clusters containing cluster data entries. K-means clustering algorithm may act to identify clusters of closely related patient data, which may be provided with user cohort labels; this may, for instance, generate an initial set of user cohort labels from an initial set of user patient data of a large number of users, and may also, upon subsequent iterations, identify new clusters to be provided new user cohort labels, to which additional user patient data may be classified, or to which previously used user patient data may be reclassified.

With continued reference to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on [symbol] dist(ci, x)², where argmin includes argument of the minimum, ci includes a collection of centroids in a set C, and dist includes standard Euclidean distance. K-means clustering module may then recompute centroids by taking mean of all cluster data entries assigned to a centroid's cluster. This may be calculated based on ci=1/Si∨Σxi [symbol] Si^{xi}. K-means clustering algorithm may continue to repeat these calculations until a stopping criterion has been satisfied such as when cluster data entries do not change clusters, the sum of the distances have been minimized, and/or some maximum number of iterations has been reached.

Still referring to FIG. 1, k-means clustering algorithm may be configured to calculate a degree of similarity index value. A “degree of similarity index value” as used in this disclosure, includes a distance measurement indicating a measurement between each data entry cluster generated by k-means clustering algorithm and a selected patient data set. Degree of similarity index value may indicate how close a particular combination of genes, negative behaviors and/or negative behavioral propensities is to being classified by k-means algorithm to a particular cluster. K-means clustering algorithm may evaluate the distances of the combination of genes, negative behaviors and/or negative behavioral propensities to the k-number of clusters output by k-means clustering algorithm. Short distances between a set of patient data and a cluster may indicate a higher degree of similarity between the set of patient data and a particular cluster. Longer distances between a set of patient behavior and a cluster may indicate a lower degree of similarity between a patient data set and a particular cluster.

With continued reference to FIG. 1, k-means clustering algorithm selects a classified data entry cluster as a function of the degree of similarity index value. In an embodiment, k-means clustering algorithm may select a classified data entry cluster with the smallest degree of similarity index value indicating a high degree of similarity between a patient data set and the data entry cluster. Alternatively or additionally k-means clustering algorithm may select a plurality of clusters having low degree of similarity index values to patient data sets, indicative of greater degrees of similarity. Degree of similarity index values may be compared to a threshold number indicating a minimal degree of relatedness suitable for inclusion of a set of patient data in a cluster, where degree of similarity indices a-n falling under the threshold number may be included as indicative of high degrees of relatedness. The above-described illustration of feature learning using k-means clustering is included for illustrative purposes only, and should not be construed as limiting potential implementation of feature learning algorithms; persons skilled in the art, upon reviewing the entirety of this disclosure, will be aware of various additional or alternative feature learning approaches that may be used consistently with this disclosure. Feature learning algorithms may alternatively or additionally include any other suitable feature learning algorithm that may occur to persons skilled in the art upon reviewing the entirety of this disclosure, including without limitation unsupervised (or in some cases, self-supervised) neural network algorithms, particle swarm optimization algorithms, or the like.

In an embodiment, training data 124 as generated by apparatus 100 may include a plurality of entries, each entry including a plurality of patient data features correlated with one or more features of clinical outcome data. This may enable a model such as a machine-learning model and/or neural network to generate predicted and/or projected clinical outcomes, such as without limitation survival rates, probabilities, and/or periods in months, years or the like, using an input including values for plurality of features.

Further referring to FIG. 1, apparatus 100 and methods may use machine learning to predict patient mortality based on the plurality of patient data 112 and/or features 128 thereof. A “feature,” for the purposes of this disclosure, is an individual measurable property of patient data. For instance, apparatus 100 may be configured to train a machine-learning model such as a neural network, as described in further detail below, using training data 124, such that neural network produces outputs indicative of predicted clinical outcomes upon receiving inputs representing one or more features 128 of patient data as described above. For instance, and without limitation, apparatus 100 may be configured to train a linear neural network using training data 124. A “linear neural network,” as described in this disclosure, is a neural network using dense or fully connected layers, as described in further detail below. Neural network may include a supervised neural network. In some embodiments, supervised neural network may include a binary classification architecture. As used in this disclosure, a “binary neural network” is a neural network in which each activation function output is mapped to a binary or Boolean logic output, for instance by comparing activation function output to a threshold; this may effectively convert activation function to a binary activation function as described in further detail below. Neural network may construct a unified model by learning from all features simultaneously and may be capable of dynamically making new predictions for new samples. Neural network may be implemented and/or trained in any manner described in this disclosure. Features 128 may include features of patient data 112, molecular data, medical data, and/or the like.

Upon generation of a neural network and/or other machine-learning model using training data 124, such model and/or network may be tested against a wider population of patient data and/or associated clinical outcome data; such patient and/or clinical outcome data may be processed and/or labeled to identify features, which may correspond to features as described above regarding training data 124. As a result, testing may be able to compare features input to network and/or model, and outputs generated thereby, to expected outputs for the identified and/or labeled features. For example, in an embodiment, processor 104 may choose patient populations with variables in common in order to eliminate these variables. Neural network may then receive values from additional populations as input, which may be larger or smaller than the initially chosen patient populations, to test accuracy, with certain values eliminated by filtering. An actual output may then be compared to an expected output. Then, it may be determined whether the differences of the output and expected output fall within the same range. An error between the results and the expected results may be calculated. In some embodiments, a direction of error between the results and the expected results may be calculated. In some embodiments, neural network 132 may be retrained, including updating the weights of the neural network, as a function of the error between the results and the expected results and/or the direction of error between the results and the expected results. In some embodiments, if results differ from expected results by more than a preconfigured threshold, neural network may be retrained according to additional training data, which may be generated, filtered, organized, and/or labeled or identified with features according to any process described above.

Still referring to FIG. 1, apparatus 100 may be configured to determine which features and/or elements of patient data most strongly affect predictive abilities of neural network. This may be done, without limitation, by permuting features. In some embodiments, determining which features and/or elements of patient data most strongly affect predictive abilities of neural network may include using Shapley values. Shapley values may be derived from game theory. Permuting 136 features such as patient demographics or mutated genes may be used for permutation 136 tests, which may combine tests on mixtures of categorical and metric data. Processor 104 may be further configured to permute 136 features of the training data 124 in accordance with the feature's feature importance using permutation 136 tests. For the purposes of this disclosure, “feature importance” is the effect of a feature on a neural network. This estimate, together with a variance-based bound, may provide an interval for the expected error of the classifier. The error estimate itself may be most reliable when different classifiers are compared against each other. For example, in order to ascertain the importance of a given feature in predicting health outcomes, permutation tests may be used. The column of a given feature may be repeatedly shuffled and ran back through the model. In some embodiments, a median value and/or quantity may be calculated for each feature. The resulting increase/decrease in the loss metric may be recorded. For example, as a coin flip converges on 50-50 odds as the number of flips increases, the permutation may be repeated to ensure statistical representative shuffling. As used in this disclosure, a “neural network” 132 is a subcategory of machine learning model, that uses interconnected nodes in a layered structure which resemble the human brain. In an embodiment, processor 104 may permute 136 features 128 gathered from training data 124, in order to reveal the most informative 16 biomarkers, of which 15 were mutated germline genes, and 7 of these genes were reported in other cancer types. Details regarding machine learning and neural networks 132 are described further below.

With continued reference to FIG. 1, additionally, or alternatively, one or more features may be extracted or derived from “neural network embeddings,” wherein the neural network embeddings are dense, low-dimensional representation of data that are learned by a neural network, for example, and without limitation, in an unsupervised or semi-supervised manner. In some cases, one or more neural network embeddings may be configured to capture complex relationships and patterns in patient data that may not be immediately apparent with feature engineering techniques as described above. In a non-limiting example, identifying features from neural network embeddings may include training a neural network on a dataset consisting of genetic variants, gene expressions, phenotypic data, and/or the like. In some cases, neural network may be configured to learn an embedding for each gene or variant that effectively summarizes its properties and the context in which it may occur within patient data. In some cases, these embeddings may be formed in one or more hidden layers of the neural network through dimensionality reduction as described in detail below, where the high-dimensional input data is mapped to a lower-dimensional space that preserves relevant information. Once the neural network has been trained, embeddings may be extracted and used as features in one or more downstream machine learning tasks. In a non-limiting example, one or more embeddings may encapsulate a collective influence of multiple variants within a particular gene, interactions between genes, and even non-linear relationships that are predictive of disease phenotypes. Thus, in some cases, resulting neural network-derived features may then be used to augment training data 124.

With continued reference to FIG. 1, in some embodiments, apparatus 100 may be configured to output a plurality of ranked features 140. Plurality of ranked features 140 may include features 128 that have been ranked. In some embodiments, ranked features 140 may include features 128 that have been ranked based on projected patient mortality. In some embodiments, ranked features 140 may include features 128 that have been ranked based on how strongly features affect the predictive abilities of neural network; as a non-limiting example, this may include using permutation tests as described above. In some embodiments, plurality of ranked features 140 may include a plurality of biomarkers. In some embodiments, apparatus 100 may output germline genes 144. In some embodiments, apparatus 100 may output germline genes 144 in a ranked list. In some embodiments, apparatus 100 may output germline genes 144 that have been ranked based on projected patient mortality. Germline genes 144 may include a subset of features 128.

Aspects of the present disclosure may be used to improve cancer treatment, gene therapy, and our general understanding of epigenetics, transcriptomics, and proteomics. Aspects of the present disclosure may also be used to improve diagnostics, prognostics, drug response data and companion diagnostics, for both clinicians and patients. This is so, at least in part, because aspects of the present disclosure may allow for use of non-invasively collected patient data 112, such as blood sample collection to obtain germline 144 blood cells, in order to make predictions relating to patient mortality. As used in this disclosure, “germline” 144 refers to germline 144 blood cells, the DNA of which one inherits from the egg and sperm cells during conception. These methods may be unlike those which are currently available. At present, clinicians typically use invasive techniques such as tissue biopsy to acquire relevant patient data 112 which may be both more painful for the patient and biologically inaccurate. Specifically, methods of this disclosure have shown that germline 144 blood cell mutations may provide the strongest and most accurate predictors of health outcomes. Exemplary embodiments illustrating aspects of the present disclosure are described below in the context of several specific examples.

For example, patients diagnosed with muscle-invasive bladder cancer (MIBC) currently have an expected survival rate of less than five years, and clinical indicators of survival are limited to association with gender and tumor stage. Even after surgical removal of all cancerous tissue, patients will still most likely die within five years given the aggressive nature of the cancer. However, using a cohort of bladder cancer patients derived from the National Cancer Institute's biobank, The Cancer Genome Atlas (TCGA), a machine learning model was trained to predict biomarkers specifically of MIBC. A 5-year MIBC survival cohort was derived from 117 patients. 78 of these patients (39 alive, 39 dead) were propensity matched based on features 128. Given that the cohort was imbalanced toward death, the other 39 dead patients were set aside as a holdout for additional validation of the neural network 132. Overall, the mutated germline 144 genes were more prevalent. The highly differentiated features from each dataset were used in combination to train a neural network 132 in order to predict five-year MIBC survival. The algorithm achieved a combined evaluation accuracy of 94.9% (validation, test, holdout). Permutation 136 of the algorithm revealed the most informative features.

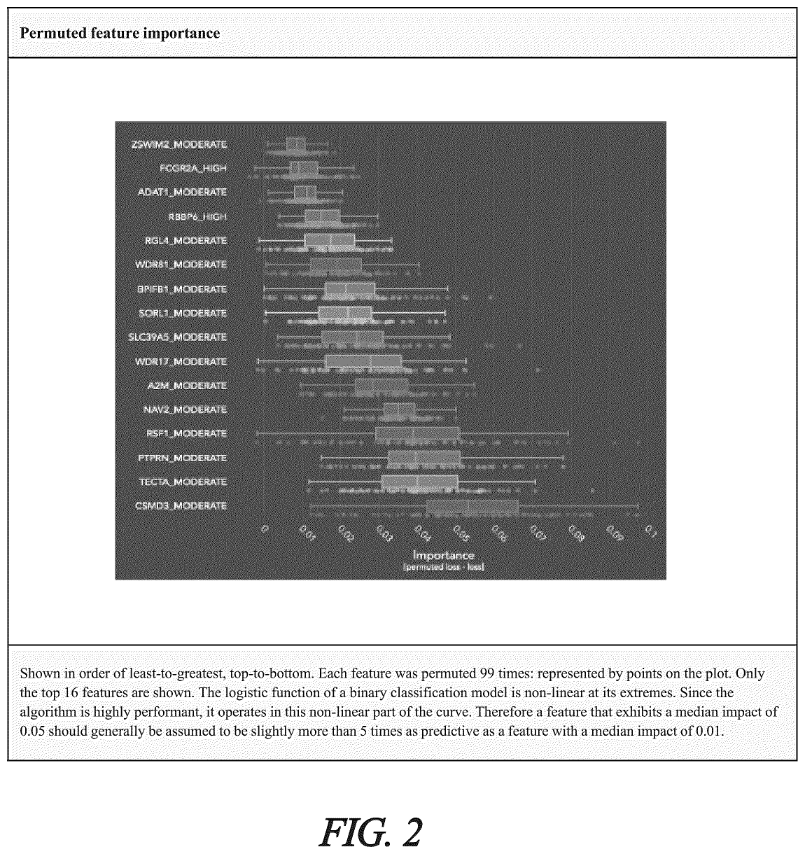

Referring now to FIG. 2, results of the above-described permutation testing and evaluation are illustrated. As indicated in the box-whisker plots, it was determined that some features had a greater impact on accurate prediction and/or outputs than others.

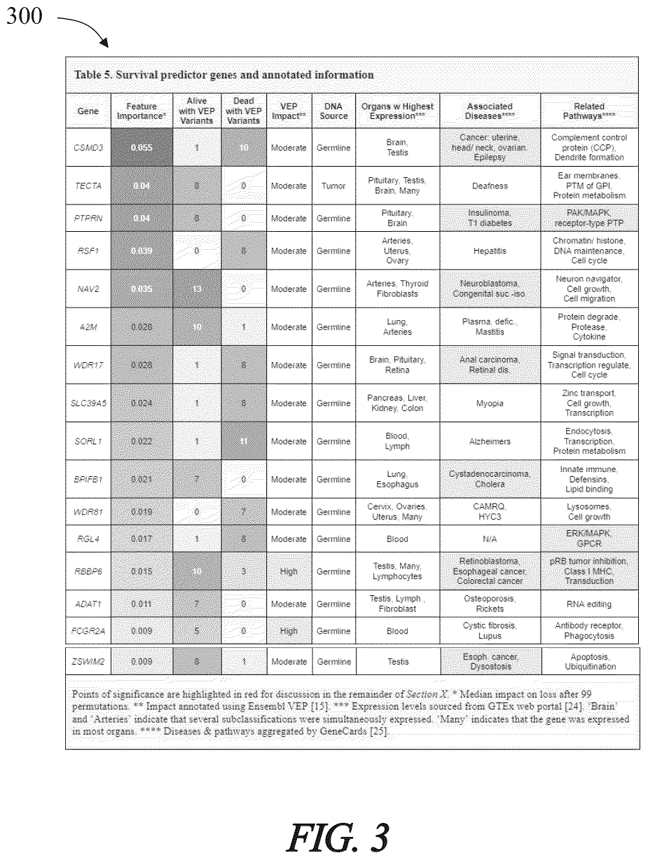

Referring to FIG. 3, a table 300 including survival predictor genes and annotated information. Table 300 also includes, for each of the survivor predictor genes, feature importance, alive patients with pathogenic variants, dead patients with pathogenic variants, VEP impact, DNA source, Organs with the highest expression, associated disease(s), and related pathways. In an experimental example, a top 16 most predictive biomarkers, 15 were mutated germline 144 genes. When inspecting the specific mutations of these top genes, 11 of them were found to possess locus-specific alleles that were repeated in 3 or more patients. This result may indicate the potentially substantial role of germline 144 and host environment in driving the behavior and outcome of MIBC. In an embodiment, processes and/or apparatuses described in this disclosure may provide a more cost-effective panel of biomarkers than is currently available to the public. In some embodiment, biomarkers selected as the panel may permit substantial reduction of sequencing required to obtain accurate results; for instance, in an experimental finding, a panel of 16 biomarkers was found to present a 99.9% reduction in the amount of sequencing in comparison to Whole Exome Sequencing (WES); 24,000 genes.

Still referring to FIG. 3, once the patient data 112 and molecular data 120 have been curated, the data may be prepared for analysis. The aiqc.mlops.Pipeline API may be used to preprocess the data. As a non-limiting example RNA-seq expression quantification data may contain outliers, which may lead to exploding gradients and overfitting during neural network training. However, given the small size of the cohort, a RobustScaler preprocessor may be employed, which may enable more aggressively scaling outliers for a given feature without pressuring the rest of the values down to zero. Further, RobustScaler software may set wide bounds for the quantile range parameter, which may enables the distribution to be more evenly distributed between 0 and 1, while severe outliers may be allowed room to manifest themselves without exaggeration. In some embodiments, StandardScaler software with default settings may be used to scale the number of qualified mutations for each differentially filtered gene from each patient. LabelBinarizer software with default settings may be used to label dead patients as 1 and alive patients as 0. Artificial Intelligence Quality Control (AIQC) may make use of scikit-learn (sklearn) for stratifying and encoding data. Stratification may refer to the 78 propensity matched samples are randomly stratified into 3 equally distributed subsets (referred to as splits) of alive and dead patients. The holdout data may serve as a 4th split for additional validation purposes. In an embodiment, neural network may be unique in its cross-functional harmonization of clinical, genomic, and deep learning methodologies. The algorithm may be trained on the Train split while simultaneously being evaluated against the Validation samples before being tested against the Test samples. More emphasis may be placed upon the Validation split than the Test split because early-stopping (or termination of training) may be triggered by the algorithm's accuracy during evaluation.

With continued reference to FIG. 3, aiqc.mlops.ExperimentAPI may be used to orchestrate neural network 132 training runs, train tune hyperparameters, and score the performance of models. Although this particular model may be developed using the TensorFlow deep learning library, AIQC may also provide high-level abstractions for PyTorch, an open-source machine learning framework. The architecture of the linear, binary-classification neural network 132 may be rudimentary. The shallow and narrow shape of the network means that it may use fewer parameters and may be less prone to overfitting. Cross-validation should not be utilized due to the inherently small size of longitudinal cohorts. The propensity matching based on strict 5-year survival may suppress phenotypic variation in order to amplify the biological signal.

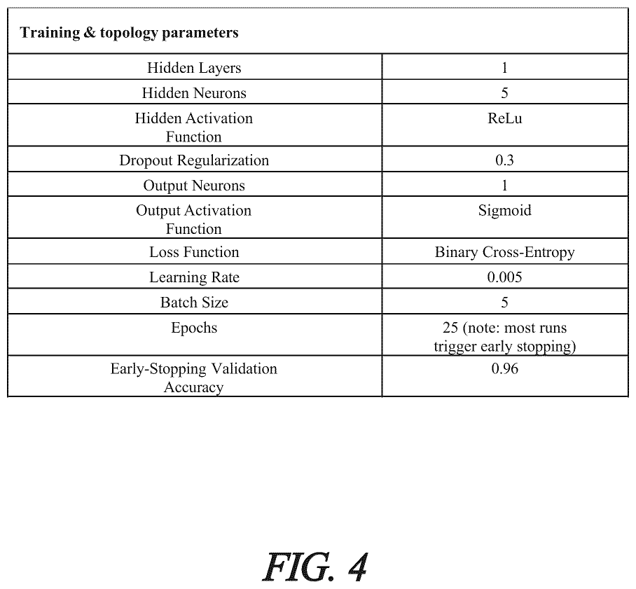

Now referring to FIG. 4 where linear network topologies are densely connected and a network such as neural network has a hidden layer, different features may have opportunities to interact with each other as their weights intersect at each hidden neuron and/or layers of neurons. This may be important because biology is bidirectional; genes influence each other in networks, and the negative impact of mutated, pathogenic oncogenes may be counteracted by genes mutated in a protective manner. This comprehensive level of interaction may not be present in traditional machine learning models like decision trees. In contrast to the industry-standard approach to quantifying molecular variation in cancer, such as Tumor Mutation Burden (TMB), which measures mutations per million base pairs, neural network in an embodiment may aggregate functionally informed variants at the gene level, differentiates those genes with respect to health outcomes, and may not ignore the germline 144 genome; an exemplary embodiment of experimentally identified correlations as identified using embodiments of methods described herein is illustrated. Additionally, or alternatively, feature engineering techniques, both matching and differential quantification, may reduce dimensionality by curating the most informative elements of the dataset. In some embodiments, rather than an association study that tests many molecular variants in isolation only to produce static summary statistics, neural network 132 may be trained on all gene-level features in unison and may produce a predictive model that may be used to prognosticate future patients.

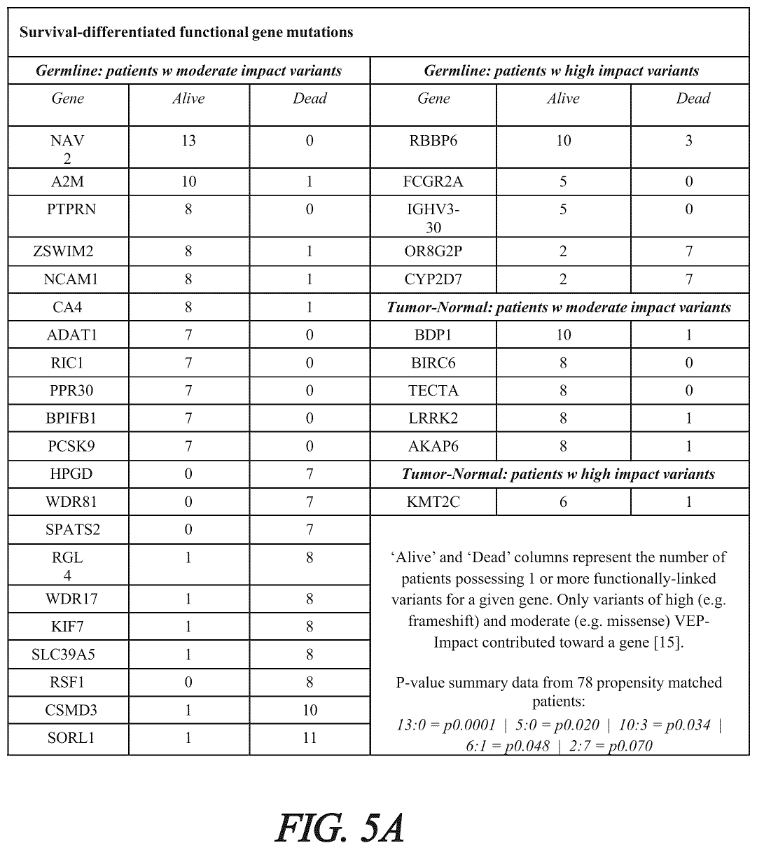

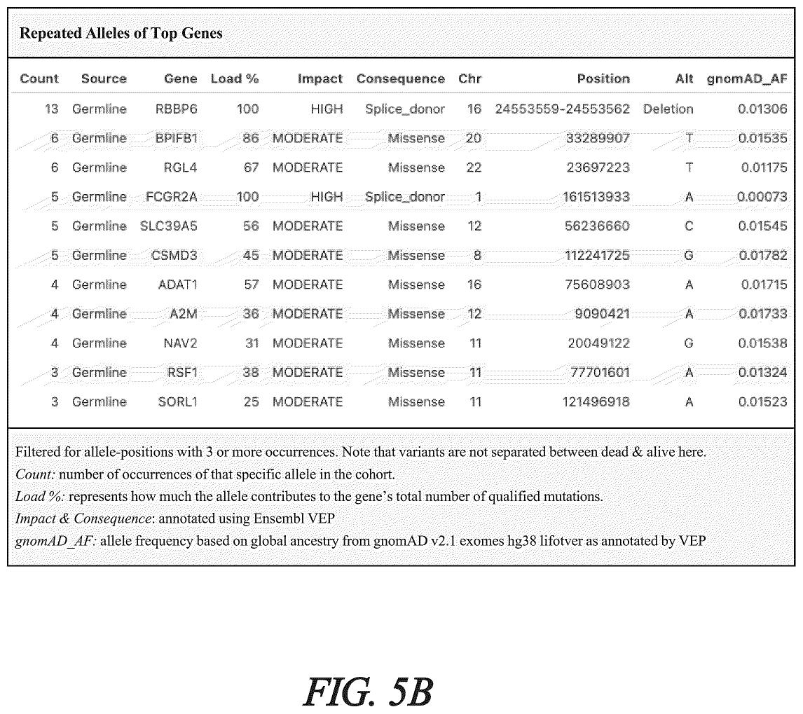

Now referring to FIGS. 5A and 5B, in a non-limiting example, a small set of genes may be curated by quantifying the mutations in dead versus alive patients. Ultimately, these methods may help control for non-molecular variance between cases and controls thereby amplifying the biological signal observed by the neural network, which may be the most effective way to make survivability predictions for patients.

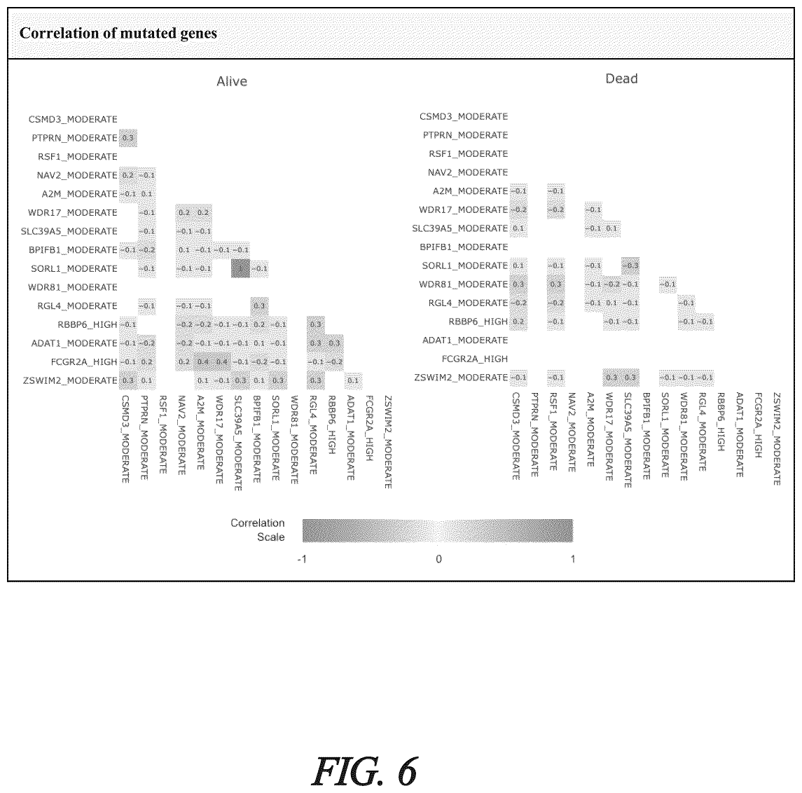

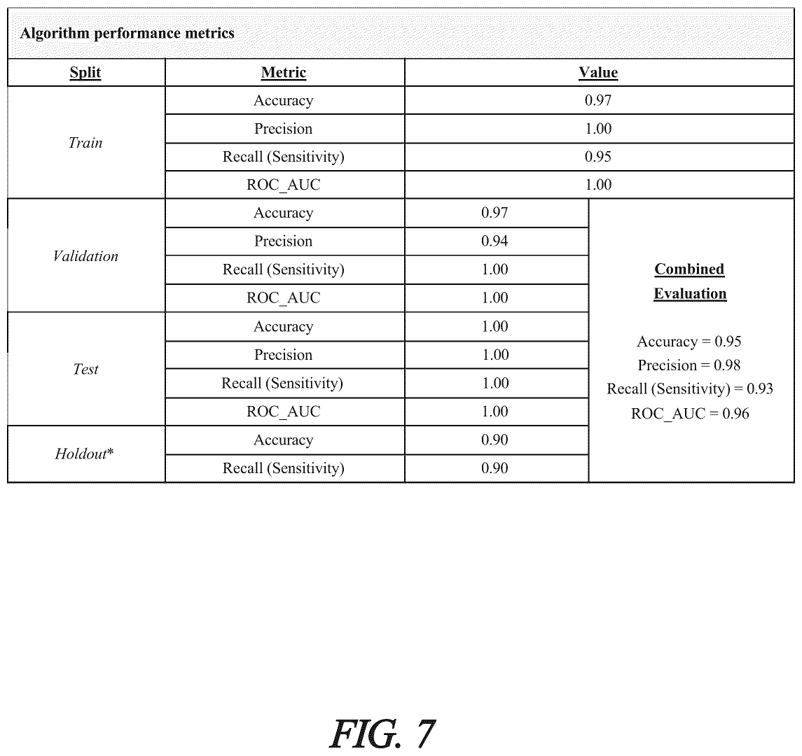

Now referring to FIGS. 6 and 7, Multiple data entries in training data 104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 104 according to various correlations; correlations may indicate causative and/or predictive links between categories of data elements, which may be modeled as relationships such as mathematical relationships by machine-learning processes as described in further detail below. Training data 104 may be formatted and/or organized by categories of data elements, for instance by associating data elements with one or more descriptors corresponding to categories of data elements. As a non-limiting example, training data 104 may include data entered in standardized forms by persons or processes, such that entry of a given data element in a given field in a form may be mapped to one or more descriptors of categories. Elements in training data 104 may be linked to descriptors of categories by tags, tokens, or other data elements; for instance, and without limitation, training data 104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, training data 104 may include one or more elements that are not categorized; that is, training data 104 may not be formatted or contain descriptors for some elements of data. Machine-learning algorithms and/or other processes may sort training data 104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 104 to be made applicable for two or more distinct machine-learning algorithms as described in further detail below. Training data 104 used by computing device may correlate any input data as described in this disclosure to any output data as described in this disclosure.

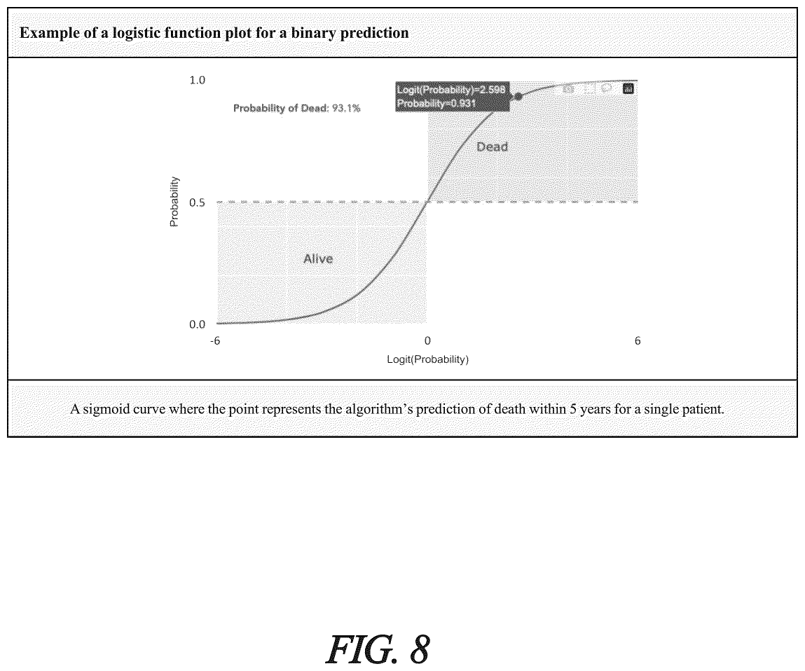

Now referring to FIG. 8, a logistic function plot representing aspects of a neural network process is illustrated. In an embodiment, logistic function may be used by neural network 132 to permute molecular features to quantify the importance of one or more molecular biomarkers related to health outcomes as described herein.

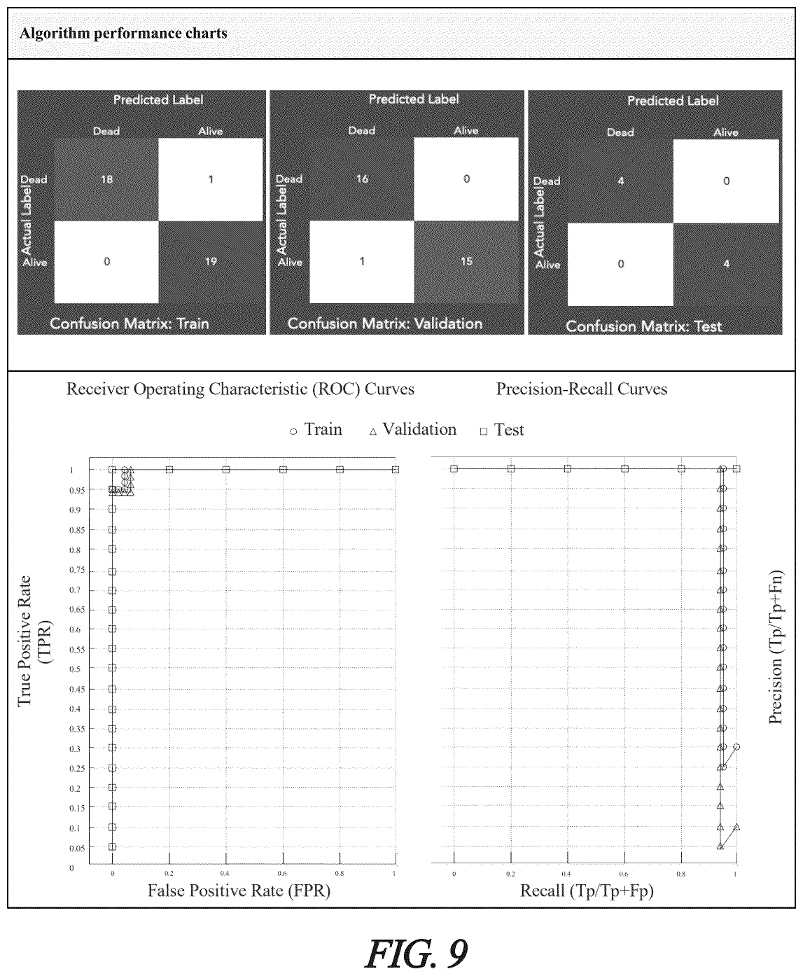

Now referring to FIG. 9, a table illustrating particular algorithm performance metrics is shown. Illustrated algorithm may be utilized in an exemplary workflow in one embodiment of the present invention as described herein.

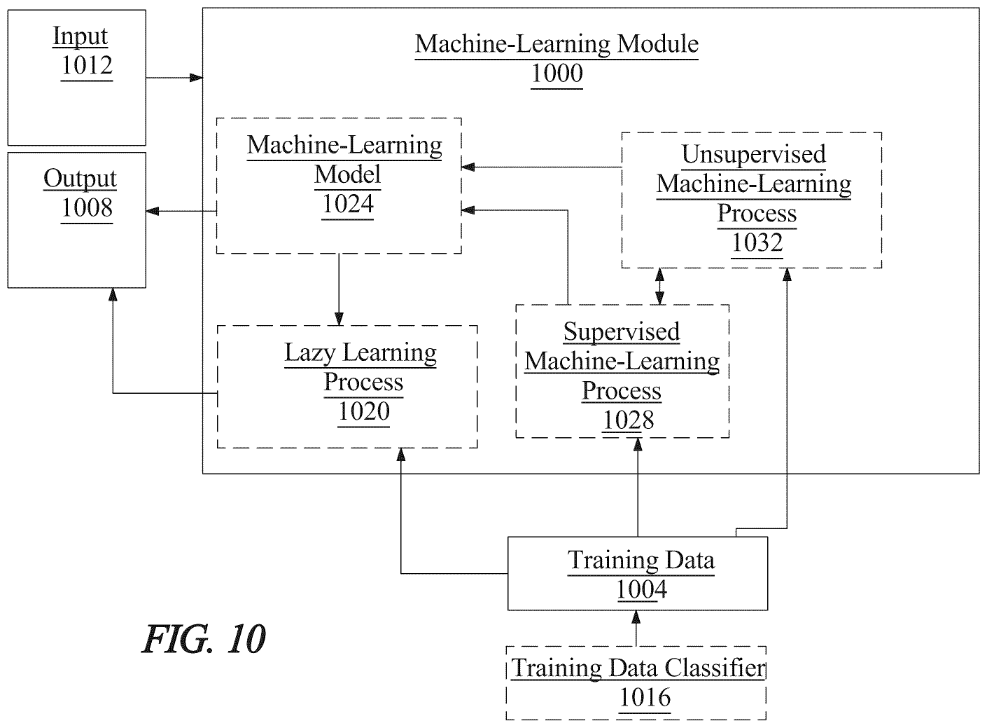

Referring now to FIG. 10, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include Bayesian statistics. As a non-limiting example, Bayesian statistics may include lazy naïve Bayes methods, naïve Bayes methods, or the like. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural network algorithms, including linear, convolutional, and/or attentive architectures.

Still referring to FIG. 10, machine-learning algorithms may include a binary classification neural network. A “binary classification neural network” or a neural network with “binary architecture,” is a neural network that is configured to classify elements into two groups. As a non-limiting example, a binary classification neural network may be used to classify elements in order to determine whether or not a patient will survive a disease. In some embodiments, machine-learning algorithms may use multi-label classification. “Multi-label classification,” also referred to as “multi-output classification,” is a variant of the classification problem where multiple nonexclusive labels may be assigned to each instance. As a non-limiting example, multi-label classification may be used to delineate between multiple disease subtypes or stages of progression.

Still referring to FIG. 1, processor 104 may compute a score associated with each clinical feature 128 and select features 128 to minimize and/or maximize the score, depending on whether an optimal result is represented, respectively, by a minimal and/or maximal score; a mathematical function, described herein as an “objective function,” may be used by processor 104 to score each possible pairing. Objective function may be based on one or more objectives as described below. In various embodiments a score of a particular clinical feature 128 may be based on a combination of one or more factors, including clinical outcome data 116, training data 124, and the like. Each factor may be assigned a score based on predetermined variables. In some embodiments, the assigned scores may be weighted or unweighted.

Optimization of objective function may include performing a greedy algorithm process. As a non-limiting example, preforming a greedy algorithm process may be done to increase the speed of learning through gradient descent. For example, this may include dynamically adjusting the learning rate used during gradient descent in order to decrease the number of training cycles required to reach the globally optimal solution. A “greedy algorithm” is defined as an algorithm that selects locally optimal choices, which may or may not generate a globally optimal solution. For instance, processor 104 may weight features 128 so that scores associated therewith are the best score for each clinical feature 128.

Still referring to FIG. 1, objective function may be formulated as a linear objective function, which processor 104 may solve using a linear program such as without limitation a mixed-integer program. A “linear program,” as used in this disclosure, is a program that optimizes a linear objective function, given at least a constraint. For instance, such as a patient age group, element of patient data 112, clinical outcome 116, molecular data 120, subset of features 128, and the like. In various embodiments, apparatus 100 may determine clinical feature 128 that maximizes a total score subject to an age group constraint. A mathematical solver may be implemented to solve for clinical fea-ture(s) 128 that maximizes scores; mathematical solver may implemented on processor 104 and/or another device in apparatus 100, and/or may be implemented on third-party solver.

With continued reference to FIG. 1, optimizing objective function may include minimizing a loss function, where a “loss function” is an expression an output of which an optimization algorithm minimizes to generate an optimal result. As a non-limiting example, processor 104 may assign weights relating to a set of features, which may correspond to score components as described above, calculate an output of mathematical expression using the variables, and select clinical feature 128 that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs.

Still referring to FIG. 10, models may be generated using alternative or additional artificial intelligence methods, including without limitation by creating an artificial neural network 132, such as a convolutional or attentive neural network 132 comprising an input layer of nodes, one or more intermediate layers, and an output layer of nodes. Connections between nodes may be created via the process of “training” the network, in which elements from a training data 104 set are applied to the input nodes, a suitable training algorithm (such as Levenberg-Marquardt, conjugate gradient, simulated annealing, or other algorithms) is then used to adjust the connections and weights between nodes in adjacent layers of the neural network 132 to produce the desired values at the output nodes. This process is sometimes referred to as deep learning. This network may be trained using training data 104.

Still referring to FIG. 10, machine-learning algorithms may include supervised machine-learning algorithms. Supervised machine learning algorithms, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include patient data as described above as inputs, cancer mortality rate as outputs, and a scoring function, objective function, and/or loss function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 104. Persons skilled in the art, upon reviewing the entirety of this disclosure, will be aware of various possible variations of supervised machine learning algorithms that may be used to determine relation between inputs and outputs.

Supervised machine-learning processes may include classification algorithms, defined as processes whereby a computing device derives, from training data 104, a model for sorting inputs into categories or bins of data. Classification may be performed using, without limitation, linear classifiers such as without limitation logistic regression and/or Bayesian classifier such as naïve Bayes classifiers, nearest neighbor classifiers, support vector machines, decision trees, boosted trees, random forest classifiers, and/or neural network-based classifiers. Regression may include, as a non-limiting example, quantitative outcomes such as survival duration or tumor size.

Still referring to FIG. 10, machine learning processes may include unsupervised processes. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require an output variable; unsupervised processes may be used to find interesting patterns and/or inferences between variables, to determine a degree of correlation between two or more variables, or the like.

Still referring to FIG. 10, machine-learning processes as described in this disclosure may be used to generate machine-learning models. A machine-learning model, as used herein, is a mathematical representation of a relationship between inputs and outputs, as generated using any machine-learning process including without limitation any process as described above, and stored in memory 108; an input is submitted to a machine-learning model once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model may be generated by creating an artificial neural network 132, such as a convolutional, recurrent or attentive neural network 132 comprising an input layer of nodes, one or more intermediate layers, and an output layer of nodes. Connections between nodes may be created via the process of “training” the network, in which elements from a training data 104 set are applied to the input nodes, a suitable training algorithm (such as Levenberg-Marquardt, conjugate gradient, simulated annealing, or other algorithms) is then used to adjust the connections and weights between nodes in adjacent layers of the neural network 132 to produce the desired values at the output nodes. This process is sometimes referred to as deep learning.

A lazy-learning process and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 104. Heuristic may include selecting some number of highest-ranking associations and/or training data 104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

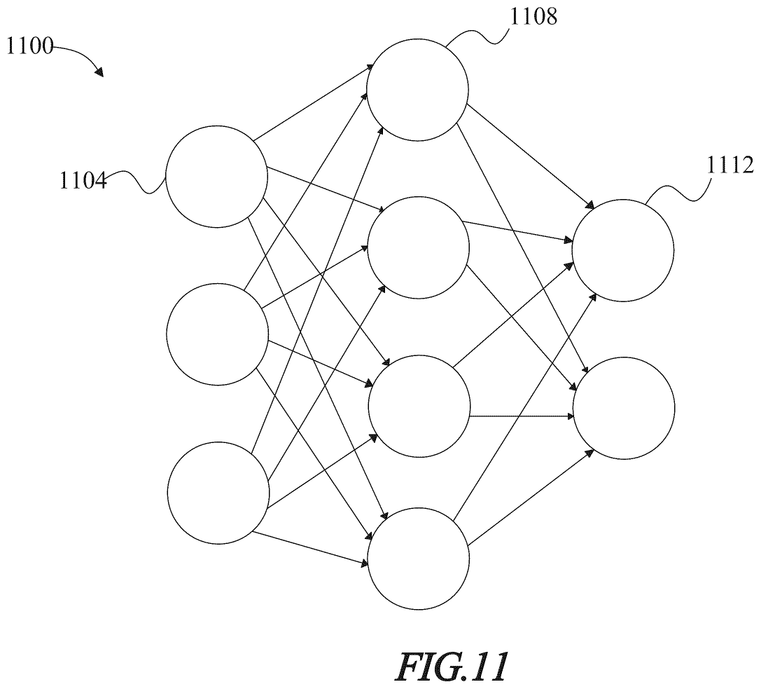

Referring now to FIG. 11 an exemplary embodiment of neural network 1100 is illustrated. Neural network 1100 may be consistent with neural network 132 as described above. A neural network 1100 also known as an artificial neural network, is a network of “nodes,” or data structures having one or more inputs, one or more outputs, and a function determining outputs based on inputs. Such nodes may be organized in a network, such as without limitation a convolutional, recurrent or attentive neural network, including an input layer of nodes 1104, one or more intermediate layers 1108, and an output layer of nodes 1112. Connections between nodes may be created via the process of “training” the network, in which elements from a training data 124 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. For the purposes of this disclosure, an “attentive neural network” is a type of neural network architecture that focuses on selectively attending to specific parts of input data while performing a task.

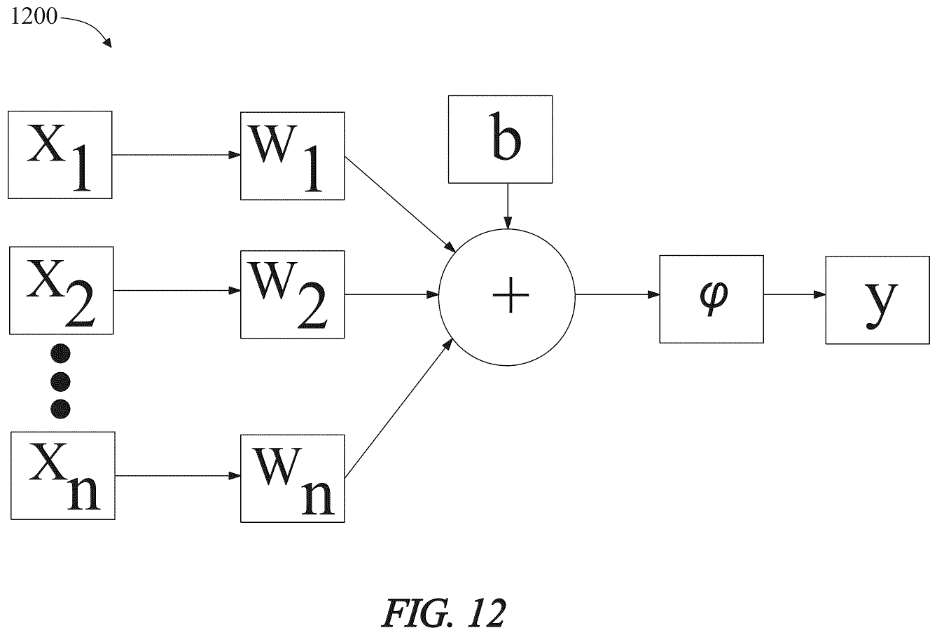

Referring now to FIG. 12, an exemplary embodiment of a node 1200 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}xforx \geq 0 \\ α ( {e}^{x} - 1 ) forx < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tan h (\sqrt{2/π}(x+bx^{r})) for some values of a b and r, and/or a scaled exponential linear unit function such as

$$f ( x ) = λ \{ \begin{matrix}α ( {e}^{x} - 1 ) forx < 0 \\ xforx \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data 124, which may be performed using any suitable process as described above.

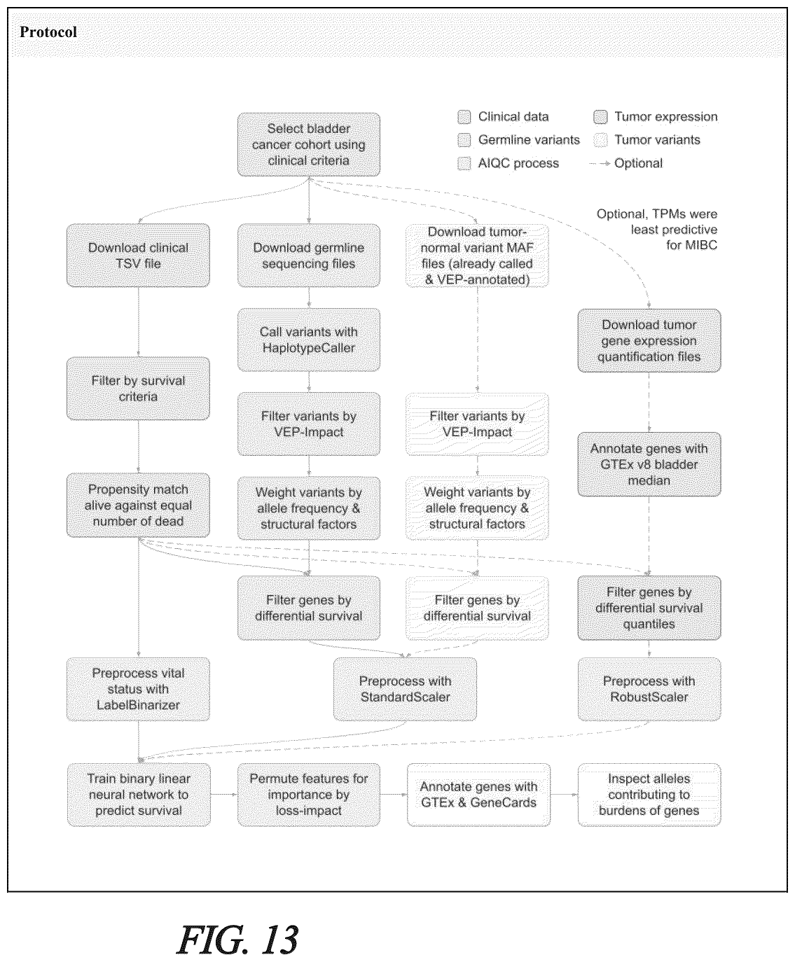

Referring now to FIG. 13, a flow chart of an exemplary embodiment of method as described herein is illustrated. In an embodiment, described method of discovering biomarkers of health outcomes using machine learning may include a use of protocol as shown in FIG. 13.

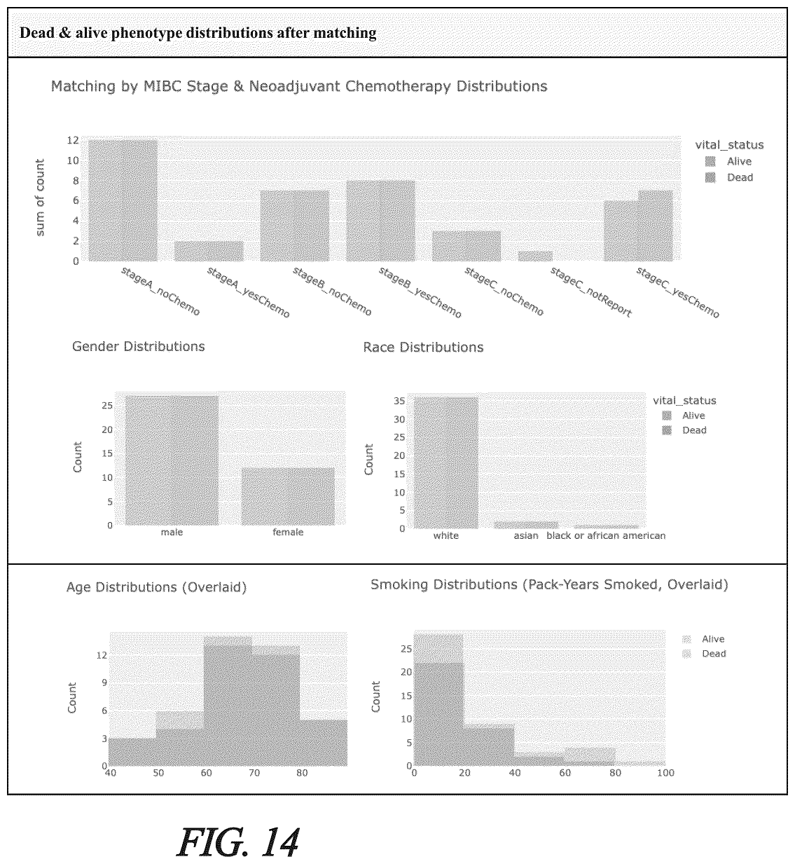

Now referring to FIG. 14, a schematic diagram illustrating final outputs of the method as described herein is shown. Such result may include a result of dead and alive phenotype distributions after matching as described above with reference to FIG. 1.

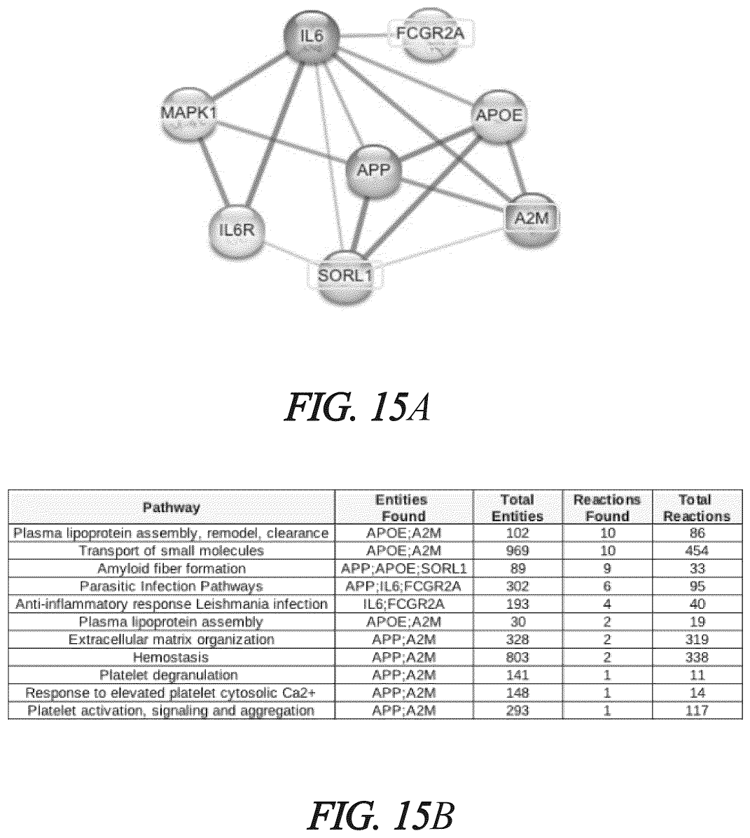

Referring now to FIG. 15A, FIG. 15A is an illustration of protein—protein interaction network derived from a functionally mutated gene set in bladder cancer survival. Functionally mutated gene set in 5-year bladder cancer survival may include CSMD3, TECTA, PTPRN, RSF1, NAV2, A2M, WDR17, SLC39A5, SORL1, BPIFB1, WDR81, RGL4, RBBP6, ADAT1, FCGR2A and ZSWIM2, where the gene set is prioritized by permuted feature importance. This mutated gene set may account for 90% of total feature importance. In some embodiments, interaction may be sourced from Search Tool for the Retrieval of Interacting Genes/Proteins (STRING) database. For the purposes of this disclosure, “Search Tool for the Retrieval of Interacting Genes/Proteins database” is a bioinformatics database and resource that collects and integrates information on protein-protein interactions, as well as other types of functional associations, such as genetic interactions, co-expression, and shared pathway involvement. As shown in FIG. 15A, edge darkness may indicate confidence. For the purposes of this disclosure, “confidence” is the level of certainty or reliability associated with an edge connecting two nodes. As a non-limiting example, edge darkness between APP and APOE may be darker than edge darkness between IL6R and SORL1, where confidence of APP and APOE interaction is higher than IL6R and SORL1 interaction.

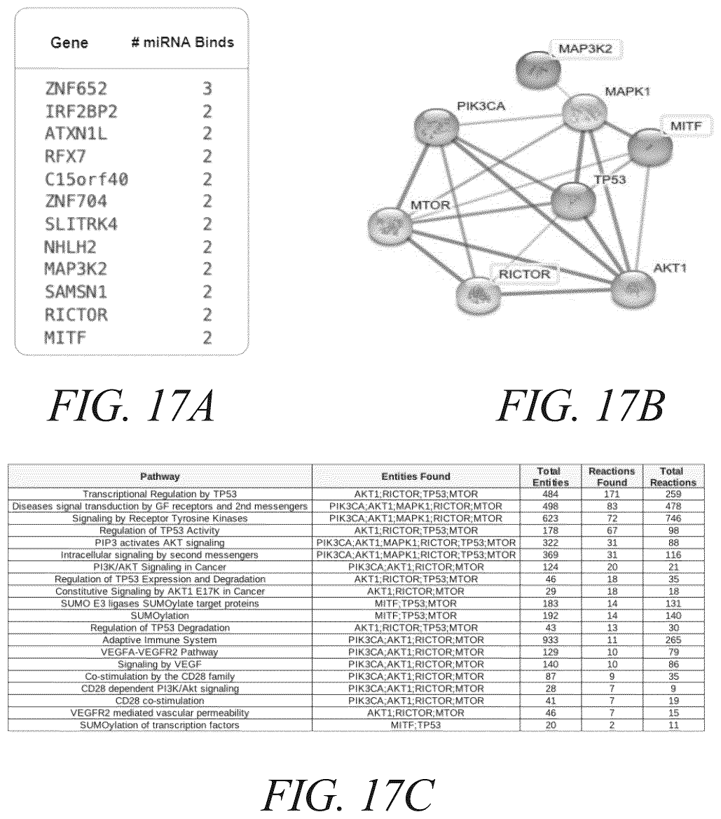

With continued reference to FIG. 15A, in some embodiments, memory 108 may contain instructions further configuring processor 104 to map algorithm-prioritized biomarkers to biological pathways. For the purposes of this disclosure, “algorithm-prioritized biomarker” is a biomarker is prioritized based on specific algorithms or statistical methods. For the purposes of this disclosure, “biological pathway” is a series of interconnected biochemical reactions and molecular events that work together to achieve a specific biological outcome or cellular function. In some embodiments, non-coding RNA (ncRNA) may be mapped to genes based on mRNA binding for miRNA analysis. For the purposes of this disclosure, “mRNA binding” is the interaction between messenger RNA molecules and other molecules through specific molecular interactions. In some embodiments, prioritized genes may be analyzed for protein-protein interaction as described with respect to FIG. 15A and FIG. 17B. For the purposes of this disclosure, “protein-protein interactions” are physical interactions between two or more proteins in a biological system. In some embodiments, pathway enrichment analysis may be performed on resulting protein interaction network as described with respect to FIG. 15B and FIG. 17C. For the purposes of this disclosure, “pathway enrichment analysis” is a bioinformatics method used to determine whether a set of genes or proteins of interest is observed in the chemical reactions of a biological pathway.

Referring now to FIG. 15B, FIG. 15B illustrates a table of pathway enrichment for reactions between genes in interaction network. In some embodiments, known pathways may be enriched for reactions between genes in interaction network, where the interaction network is described above with respect to FIG. 15A. In some embodiments, genes within 1 hop of the original gene set may be included in the analysis. In some embodiments, reactions may be sourced from Reactome database. In some embodiments, pathways with less than 1,000 entities may be filtered. In some embodiments, pathways that include at least 1 interaction may be included. For the purposes of this disclosure, “Reactome database” is a database that provides information about biological pathways, processes, and their molecular components.

With continued reference to FIG. 15B, pathway enrichment analysis may systematically identify biological pathways that are significantly associated with a set of genes, such as those mutated in cancer. In one or more embodiments, pathways may be determined through one or more reactions between genes within an interaction network, which can include direct interactions or those within one hop of the original gene set.

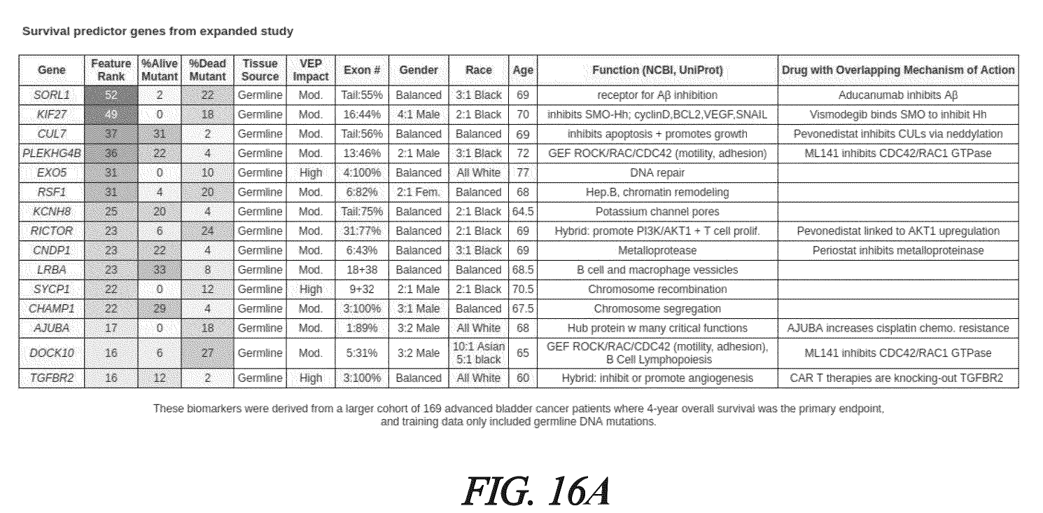

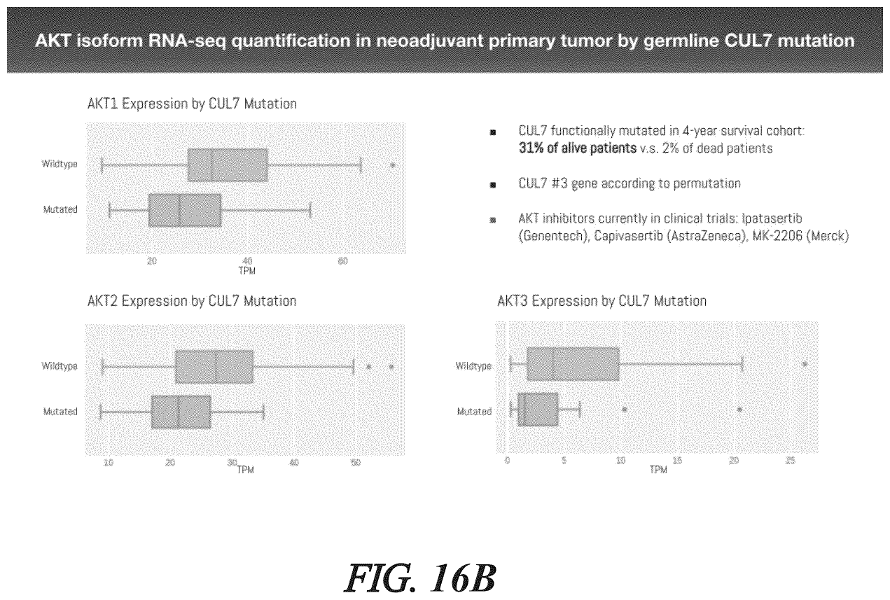

Now referring to FIGS. 16A and 16B, a table illustrating survival predictor genes from an expanded study and the corresponding study result is shown. In the context of oncology, in some cases, genes that participate in pathways overlapping with the mechanism of action of a drug may be considered as prime candidates for repurposing of existing drugs for new cancer indications. For instance, and without limitation, if a gene's function or the pathway in which it operates is known to be modulated by a particular drug, this gene may be a target for repurposing the drug in a new cancer context where the gene is implicated. In some embodiments, as shown in FIG. 16A genes including CUL7, KIF27, and SORL1, may each be linked to distinct insights and functions that are pertinent to cancer such as, without limitation, their corresponding mutation rates in cancer survivors or fatalities, positioning within the ranking of gene permutations, and/or the like. Function of genes may be correlate with specific drugs that act on related pathways or molecular targets. For example, and without limitation, CUL7 gene, which inhibits p53 and is functionally mutated in a significant subset of bladder cancer survivors, may be associated with the drug pevonedistat i.e., a molecule currently in clinical trials that inhibits the CUL family. Such association may underscore the potential for pevonedistat's repurposing for treating cancers involving apoptosis pathway dysregulation. In some cases, AKT expression by CUL 7 mutational status, as shown in FIG. 16B, may demonstrate the fitness of CUL 7 mutations as biomarkers for AKT inhibitor therapy. In a non-limiting example, patients with functionally mutated CUL 7 may either not need AKT inhibitor therapy ort they may require a lower dose.

Referring now to FIG. 17A, FIG. 17A illustrates a table of identified genes with which prioritized microRNA (miRNA) are predicted to bind. For the purposes of this disclosure, “microRNAs,” also called “miRNAs” are small non-coding RNA molecules. In some embodiments, miRNA may play a role in post-transcriptional regulation of gene expression. In some cases, non-coding RNA may further include long non-coding RNA (LncRNA), small nuclear RNA (SnoRNA), and silencing RNA (siRNA). In some embodiments, miRNAs may include 21-25 nucleotides in length. In some embodiments, miRNA may be involved in the control of gene expression by binding to specific messenger RNA (mRNA) molecules. In some embodiments, miRNAs may include hsa-miR-511, hsa-miR-146a, hsa-miR-625, hsa-miR-155, hsa-miR-3065, hsa-miR-1266, hsa-miR-9-2 and hsa-miR-629, where the miRNAs are differentially expressed microRNA in metastasis of colorectal cancer as prioritized by permuted feature importance. In some embodiments, the miRNAs may account for 90% total feature importance. As shown in FIG. 17A, RICTOR may include two miRNA binds, where the miRNAs may include hsa-miR-155-5p and hsa-miR-3065-5p. As shown in FIG. 17A, MAP3K2 may include two miRNA binds, where the miRNAs may include hsa-miR-511-5p and hsa-miR-3065-5p. As shown in FIG. 17A, MITF may include two miRNA binds, where the miRNAs may include hsa-miR-155-5p and hsa-miR-1266-5p. In some embodiments, binds may be aggregated at the gene level. In some embodiments, mRNA may be determined that each miRNA binds with at high (>90%) confidence based on miRDB scores. For the purposes of this disclosure, “miRDB” is a database and bioinformatics tool for miRNA target prediction. For the purposes of this disclosure, “miRDB score” is a measure used in miRNA target prediction to assess the likelihood or confidence of a predicted interaction between miRNA and a target gene. In some embodiments, in miRDB, each predicted miRNA-target interaction may include miRDB score, which quantifies the strength of the predicted interaction. As a non-limiting example, higher miRDB scores may indicate a higher likelihood of a miRNA targeting a particular gene, suggesting a stronger potential interaction. In some embodiments, mRNA reference sequence (RefSeq) identification (ID) may be converted to gene symbol. For the purposes of this disclosure, “mRNA RefSeq ID” refers to the unique identifier assigned to a specific mRNA sequence in the RefSeq database. For the purposes of this disclosure, “Reference Sequence,” also called “RefSeq” is a comprehensive database maintained by the National Center for Biotechnology Information that provides curated and annotated reference sequences for various biological molecules, including mRNA, DNA, and protein sequences.

Referring now to FIG. 17B, FIG. 17B is an illustration of protein—protein interaction network derived from miRNA-binding genes. As a non-limiting example, miRNA-binding genes may include miRNA in metastasis of colorectal cancer. For example, and without limitation, miRNA may include hsa-miR-511, hsa-miR-146a, hsa-miR-625, hsa-miR-155, hsa-miR-3065, hsa-miR-1266, hsa-miR-9-2 and hsa-miR-629, where the gene set is prioritized by permuted feature importance. The gene set may account for 90% of total feature importance. In some embodiments, interaction may be sourced from Search Tool for the Retrieval of Interacting Genes/Proteins (STRING) database. As shown in FIG. 17B, edge darkness may indicate confidence. As a non-limiting example, edge darkness between RICTOR and AKT1 may be darker than edge darkness between MITF and AKT1, where confidence of RICTOR and AKT1 interaction is higher than MITF and AKT1 interaction.

Referring now to FIG. 17C, FIG. 17C illustrates a table of pathway enrichment for reactions between genes in interaction network. In some embodiments, known pathways may be enriched for reactions between genes in interaction network, where the interaction network is described above with respect to FIG. 17B. In some embodiments, genes within 1 hop of the original gene set may be included in the analysis. In some embodiments, reactions may be sourced from Reactome database. In some embodiments, pathways with less than 1,000 entities may be filtered. In some embodiments, pathways that include at least 1 interaction may be included.

Referring now to FIG. 18, an exemplary graph used for determining plurality of variant weights associated with the genetic mutation data is illustrated. Weighting the genetic mutation data may include determine a plurality of variant multipliers as a function of at least a weighting factor e.g., AF as described above. In some cases, a higher AF may represent that corresponding variant may be more common within a given population. In a non-limiting example, a negative correlation between AF and variant multiplier may be established, wherein the negative correlation may suggest common mutations (those with a higher AF) may be penalized, by processor 104 more heavily than rare mutations during the generation of training data based on patient data—the common mutations may be less likely to be harmful or pathogenic, because they may be preserved throughout the population, whereas rare mutations could be more deleterious or have a stronger impact on health outcomes. Plurality of variant weights associated with the genetic mutation data may be further determined as a function of the variant multiplier. Thus, for example, as shown in FIG. 18, such correlation between weighting factor and variant weight may be visualized as a graph. The x-axis of the graph may represent AF expressed as percentage from 0% to 10% and the y-axis of the graph may represent variant weight or variant multiplier which ranges from 0.0 to 1.0. A multiplier of 1.0 may indicate no penalty for the variant while a multiplier closer to 0 may indicate a greater penalty. The graph may include a curve starts with a variant multiplier of 1.0 at AF of 0% and progressively slope downwards, implying that as AF increases the penalty also increases.

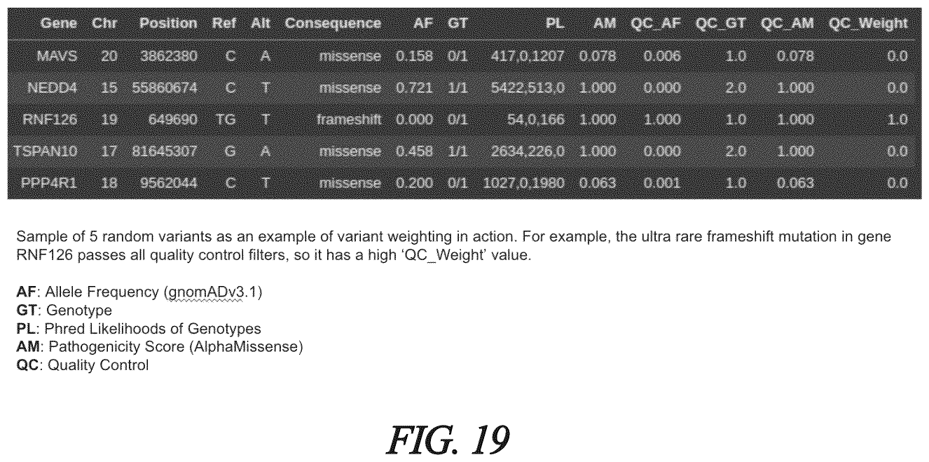

Referring now to FIG. 19, a table showing a sample of a set of random genetic variants and their corresponding gene score is illustrated. In one or more embodiments, processor 104 may be configured to calculate a gene score for each qualified gene within the filtered and weighted trained data as described above. As used in this disclosure, a “gene score” is a quantitative measure that represents a collective impact of a corresponding genetic variants within a single gene on a particular phenotype or health outcome. In some cases, gene score may include pathogenicity score previously calculated as described above, or at least in part, calculated based on the pathogenicity score associated with the gene. In some cases, gene score may include a composite measure derived from plurality of variant weights. In some cases, gene score may be calculated by aggregating the effects of individual mutations or variants found within the gene, each adjusted by their respective weighting factors. In a non-limiting example, gene score may include a quality control score, wherein the ultra-rare frameshift mutation in gene RNF126, as shown in FIG. 19, passes all quality control (QC) filters e.g., genotype QC filter, pathogenicity score QC filter, and AF QC filter, may be associated with a QC score of 1.0.

Still referring to FIG. 19, once gene score has been calculated by processor 104, a highly differential subset of qualified genes i.e., a subset of genes that exhibit a large variance in their corresponding gene scores relative to a predetermined health outcome threshold may be identified. In some cases, health outcome threshold may be established based on empirical data and statical analysis indicative of a score beyond which a particular gene is considered to have a significant association with one or more health outcome in question. Thus, at least in part, dimensionality of training data may be reduced by differentiating cases and controls utilizing calculated gene scores. In some cases, such differences may be in terms of gene score's magnitude, distribution, or other statistical measures and the like. In a non-limiting example, efficiency and performance of one or more machine learning models as described herein may be improved by configured the models to focus on the identified subset of qualified genes having a reduced number of variables (i.e., genes) that are most indicative on the condition being studied.

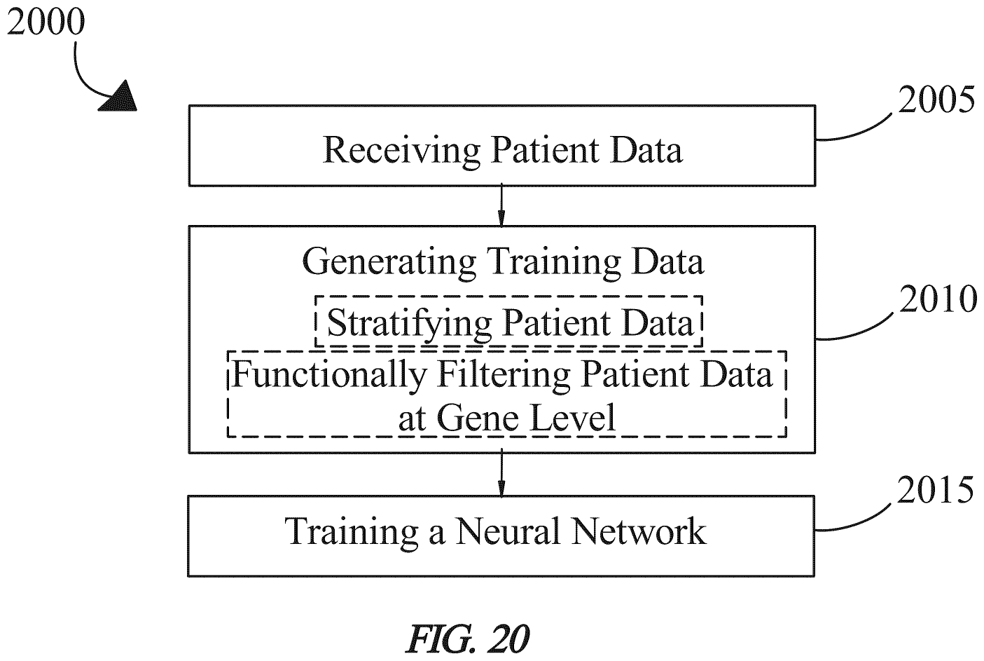

Now referring to FIG. 20, a method 2000 of discovering biomarkers of health outcomes using machine learning is illustrated for exemplary purpose. At step 2005, at least a processor 104 receives a plurality of patient data 112 wherein each element of patient data 112 includes clinical outcome data 116 and molecular data 120; this may be implemented without limitation as described above in reference to FIGS. 1-19.

At step 2010, and still referring to FIG. 20, at least a processor 104 generates training data 124 using the plurality of patient data 112, wherein the training data 124 correlates molecular data 120 to clinical outcome data 116; this may be implemented without limitation as described above in reference to FIGS. 1-19. In some embodiments, step 2010 may include stratifying patient data as described above in reference to FIGS. 1-19. In some embodiments, step 2010 may include functionally filtering and weighting patient data at a gene level as described above in reference to FIGS. 1-19. In some embodiments, step 2010 may involve the use of a functional filter as described above in reference to FIGS. 1-19. In some embodiments, step 2010 may include weighting the genetic mutation data by at least a weighting factor to adjust a plurality of variant weights associated with genetic mutation data within the patient data, wherein the at least a weighting factor may be selected from a group of weighting factors consisting of an AF and a structural impact as described above with in reference to FIGS. 1-19. In some embodiments, step 2010 may include filtering and weighting the plurality of patient data based on clinical outcome criteria and generating the training data using the filtered patient data. This may be implemented as described with reference to FIGS. 1-19. In some embodiments, step 2010 may include propensity matching patient data of the plurality of the patient data according to at least a clinical feature and generating the training data using the matched patient data. This may be implemented as described with reference to FIGS. 1-19. In some embodiments, step 2010 may include feature engineering, which may include grouping the filtered and weighted genetic mutation data into genes, qualifying the genes of the filtered and weighted genetic mutation data with respect to health outcome, and generating the training data using the qualified genes. This may be implemented as described with reference to FIGS. 1-19.

At step 2015, and with continued reference to FIG. 20, at least a processor trains a neural network using training data 124; this may be implemented without limitation as described above in reference to FIGS. 1-19. Understanding the complex biological mechanisms of cancer patient health outcomes using genomic and clinical data may be vital, not only to develop new treatments for patients, but also to improve survival prediction. The machine learning method described herein may be implemented by neural network and may reduce dimensionality prior to training through intuitive and clinical feature engineering.

With continued reference to FIG. 20, method 2000 may further include permuting features of the training data and determining a degree of effect on the predictions and/or predictive capability of the neural network as a function of the permutation. In some embodiments, determining the degree of effect on the on the predictions and/or predictive capability of the neural network as a function of the permutation may include selecting a plurality of candidate targets for therapeutics, wherein the plurality of candidate targets are features with a large degree of effect on the neural network. This may be implemented without limitation as described above in reference to FIGS. 1-19. In some embodiments, method 2000 may further include reducing the training data by differentiating the mutated genes with respect to the clinical outcome, such that the training data only retains highly differentiated genes. Additionally, or alternatively, method 2000 may further include reducing a dimensionality of the training data by calculating a gene score for each qualified gene as a function of the plurality of variant weights and identifying a subset of the qualified genes that exhibit a large variance in the gene scores relative to a predetermined health outcome threshold as a function of the calculated gene scores. This may be implemented without limitation as described above in reference to FIGS. 1-19.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

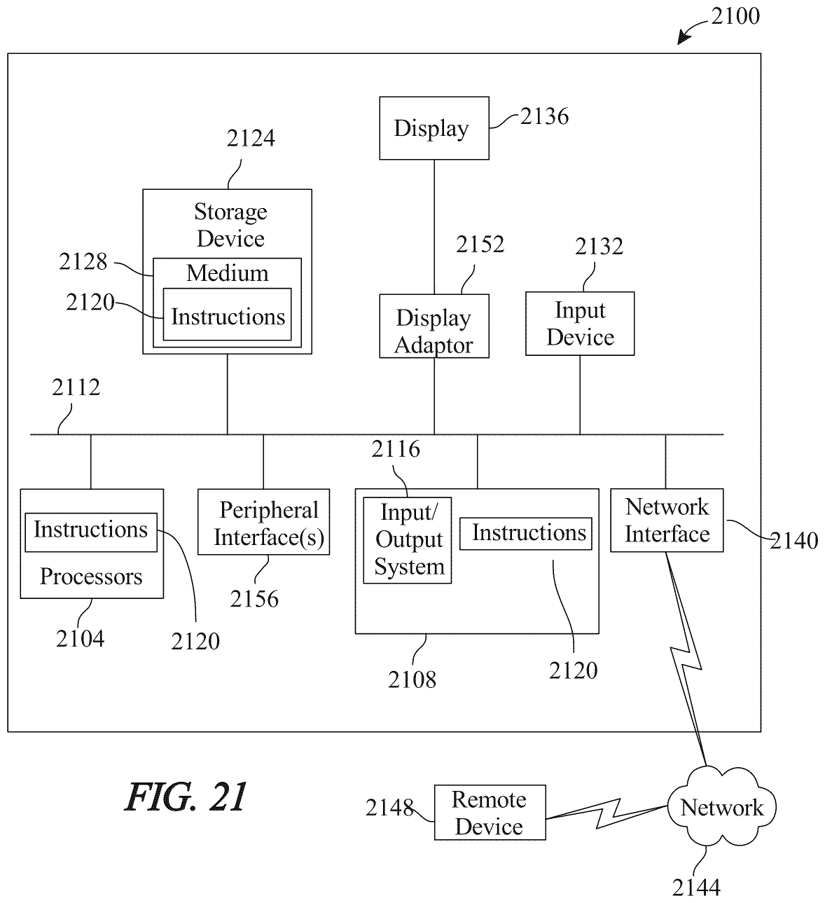

FIG. 21 shows a diagrammatic representation of one embodiment of a computing device in the exemplary form of a computer system 2100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2100 includes a processor 2104 and a memory 2108 that communicate with each other, and with other components, via a bus 2112. Bus 2112 may include any of several types of bus structures including, but not limited to, a memory bus, a memory controller, a peripheral bus, a local bus, and any combinations thereof, using any of a variety of bus architectures.

Processor 2104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2104 may be organized according to Von Neumann and/or Harvard architecture as a non-limiting example. Processor 2104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 2108 may include various components (e.g., machine-readable media) including, but not limited to, a random-access memory component, a read only component, and any combinations thereof. In one example, a basic input/output system 2116 (BIOS), including basic routines that help to transfer information between elements within computer system 2100, such as during start-up, may be stored in memory 2108. Memory 2108 may also include (e.g., stored on one or more machine-readable media) instructions (e.g., software) 2120 embodying any one or more of the aspects and/or methodologies of the present disclosure. In another example, memory 2108 may further include any number of program modules including, but not limited to, an operating system, one or more application programs, other program modules, program data, and any combinations thereof.

Computer system 2100 may also include a storage device 2124. Examples of a storage device (e.g., storage device 2124) include, but are not limited to, a hard disk drive, a magnetic disk drive, an optical disc drive in combination with an optical medium, a solid-state memory device, NVMe, PCIe, and any combinations thereof. Storage device 2124 may be connected to bus 2112 by an appropriate interface (not shown). Example interfaces include, but are not limited to, SCSI, advanced technology attachment (ATA), serial ATA (SATA), universal serial bus (USB), IEEE 1394 (FIREWIRE), and any combinations thereof. In one example, storage device 2124 (or one or more components thereof) may be removably interfaced with computer system 2100 (e.g., via an external port connector (not shown)). Particularly, storage device 2124 and an associated machine-readable medium 2128 may provide nonvolatile and/or volatile storage of machine-readable instructions, data structures, program modules, and/or other data for computer system 2100. In one example, software 2120 may reside, completely or partially, within machine-readable medium 2128. In another example, software 2120 may reside, completely or partially, within processor 2104.

Computer system 2100 may also include an input device 2132. In one example, a user of computer system 2100 may enter commands and/or other information into computer system 2100 via input device 2132. Examples of an input device 2132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2132 may be interfaced to bus 2112 via any of a variety of interfaces (not shown) including, but not limited to, a serial interface, a parallel interface, a game port, a USB interface, a FIREWIRE interface, a direct interface to bus 2112, and any combinations thereof. Input device 2132 may include a touch screen interface that may be a part of or separate from display 2136, discussed further below. Input device 2132 may be utilized as a user selection device for selecting one or more graphical representations in a graphical interface as described above.

A user may also input commands and/or other information to computer system 2100 via storage device 2124 (e.g., a removable disk drive, a flash drive, etc.) and/or network interface device 2140. A network interface device, such as network interface device 2140, may be utilized for connecting computer system 2100 to one or more of a variety of networks, such as network 2144, and one or more remote devices 2148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2144, may employ a wired and/or a wireless mode of communication. In general, any network topology may be used. Information (e.g., data, software 2120, etc.) may be communicated to and/or from computer system 2100 via network interface device 2140.

Input commands may also be received by computer system 2100 programmatically. In some embodiments, input commands may be received through an application programming interface (API). As non-limiting examples, input commands may be received through the API using protocols such as REST, SOAP, RPC, GraphQL, and the like. These protocols may be used, for example, to execute the process procedurally or to perform the process automatically on a schedule.

Computer system 2100 may further include a video display adapter 2152 for communicating a displayable image to a display device, such as display device 2136. Examples of a display device include, but are not limited to, a liquid crystal display (LCD), a cathode ray tube (CRT), a plasma display, a light emitting diode (LED) display, and any combinations thereof. Display adapter 2152 and display device 2136 may be utilized in combination with processor 2104 to provide graphical representations of aspects of the present disclosure. In addition to a display device, computer system 2100 may include one or more other peripheral output devices including, but not limited to, an audio speaker, a printer, and any combinations thereof. Such peripheral output devices may be connected to bus 2112 via a peripheral interface 2156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for discovering biomarkers of health outcomes using machine learning, the apparatus comprising:
at least a processor; and
a memory, the memory containing instructions configuring the at least a processor to:
receive a plurality of patient data, wherein each element of patient data includes clinical outcome data affecting a prediction error of a neural network and molecular data;
generate training data using the plurality of patient data;
train, using the training data, the neural network to predict clinical outcome probabilities based on the molecular data, wherein training the neural network further comprises generating a first loss metric;
generate additional training data by randomly shuffling elements of the training data associated with at least a feature;
retrain the neural network using the additional training data, wherein retraining the neural network further comprises generating a second loss metric;
determine that the second loss metric is greater than the first loss metric; and
identify, based on the determination, a significance of the at least a feature.

2. The apparatus of claim 1, wherein the training data correlates the molecular data to clinical outcome data and the molecular data further comprises germline genetic mutation data.

3. The apparatus of claim 1, wherein generating the training data further comprises:
filtering the plurality of patient data based on clinical outcome criteria; and
generating the training data using the filtered patient data.

4. The apparatus of claim 2, wherein generating the training data further comprises filtering the germline genetic mutation data using a functional filter.

5. The apparatus of claim 2, wherein generating the training data further comprises:
weighting the germline genetic mutation data by at least a weighting factor to adjust a plurality of variant weights associated with the germline genetic mutation data, wherein the at least a weighting factor is selected from a group of weighting factors consisting of an Allele Frequency (AF) and a structural impact.

6. The apparatus of claim 5, wherein generating the training data further comprises feature engineering including:
grouping the filtered and weighted germline genetic mutation data by genes;
qualifying the genes of the filtered and weighted germline genetic mutation data with respect to health outcome; and
generating the training data using the qualified genes.

7. The apparatus of claim 6, wherein generating the training data comprises reducing a dimensionality of the training data by calculating a gene score for each qualified gene as a function of the plurality of variant weights and identifying a subset of the qualified genes that exhibit a large variance in the gene scores relative to a predetermined health outcome threshold as a function of the calculated gene scores.

8. The apparatus of claim 1, wherein the neural network is a linear topology that promotes an interaction between features.

9. The apparatus of claim 2, wherein generating the training data further comprises:
propensity matching patient data of the plurality of the patient data according to at least a clinical feature; and
generating the training data using the matched patient data.

10. The apparatus of claim 1, wherein:
the training data includes a plurality of features; and
the at least a processor is further configured to:
permute features of the training data, after training the neural network; and
determine a degree of effect on predictions of the neural network as a function of the permutation, wherein determining the degree of effect on the predictions of the neural network comprises:
selecting a plurality of candidate targets for therapeutics, wherein the plurality of candidate targets are features related to a drug's mechanism of action with a large degree of effect on the predictions of the neural network.

11. The apparatus of claim 1, wherein the memory contains instructions further configuring the at least a processor to:
map algorithm-prioritized biomarkers to biological pathways; and
perform a pathway enrichment analysis on protein-protein interactions to map the algorithm-prioritized biomarkers to the biological pathways.

12. A method of discovering biomarkers of health outcomes using machine learning, the method comprising:
receiving, by at least a processor, a plurality of patient data wherein each element of patient data includes clinical outcome data affecting a prediction error of a neural network and molecular data;
generating, by the at least a processor, training data using the plurality of patient data;
training, by the at least a processor, using the training data, the neural network to predict clinical outcome probabilities based on the molecular data, wherein training the neural network further comprises generating a first loss metric:
generating, by the at least a processor, additional training data by randomly shuffling elements of the training data associated with at least a feature:
retraining, by the at least a processor, the neural network using the additional training data, wherein retraining the neural network further comprises generating a second loss metric:
determining, by the at least a processor, that the second loss metric is greater than the first loss metric; and
identifying, by the at least a processor, based on the determination, a significance of the at least a feature.

13. The method of claim 12, wherein the training data correlates the molecular data to clinical outcome data and the molecular data further comprises germline genetic mutation data.

14. The method of claim 12, wherein generating the training data further comprises:
filtering the plurality of patient data based on clinical outcome criteria; and
generating the training data using the filtered patient data.

15. The method of claim 13, wherein generating the training data further comprises filtering the germline genetic mutation data using a functional filter.

16. The method of claim 13, wherein generating the training data further comprises:
weighting the germline genetic mutation data by at least a weighting factor to adjust a plurality of variant weights associated with the germline genetic mutation data, wherein the at least a weighting factor is selected from a group of weighting factors consisting of an Allele Frequency (AF) and a structural impact.

17. The method of claim 16, wherein generating the training data further comprises feature engineering including:
grouping the filtered germline genetic mutation data by genes;
qualifying the genes of the filtered germline genetic mutation data with respect to health outcome; and
generating the training data using the qualified genes.

18. The method of claim 17, wherein generating the training data comprises reducing a dimensionality of the training data by calculating a gene score for each qualified gene as a function of the plurality of variant weights and identifying a subset of the qualified genes that exhibit a large variance in the gene scores relative to a predetermined health outcome threshold as a function of the calculated gene scores.

19. The method of claim 12, wherein the neural network is a linear topology that promotes an interaction between features.

20. The method of claim 13, wherein generating the training data further comprises:
propensity matching patient data of the plurality of the patient data according to at least a clinical feature; and
generating the training data using the matched patient data.

21. The method of claim 12, wherein:
the training data includes a plurality of features; and
the method further comprises:
permuting features of the training data after training the neural network; and
determining a degree of effect on predictions of the neural network as a function of the permutation, wherein determining the degree of effect on the predictions of the neural network comprises:
selecting a plurality of candidate targets for therapeutics, wherein the plurality of candidate targets are features related to a drug's mechanism of action with a large degree of effect on the neural network.

22. The method of claim 12, further comprising:
mapping, using the at least a processor, algorithm-prioritized biomarkers to biological pathways; and
performing, using the at least a processor, a pathway enrichment analysis on protein-protein interactions to map the algorithm-prioritized biomarkers to the biological pathways.
